(19) United States
(12) Patent Application Publication
(10) Pub. No.: US 2026/0178890 A1
(43) Pub. Date: Jun. 25, 2026

(54) EFFICIENT CPU-BASED NEURAL NETWORK INFERENCE IN LOW-LATENCY ENVIRONMENTS

(71) Applicant: Aurora Operations, Inc., Pittsburgh, PA (US)

(72) Inventors: Steve Christopher Bako, San Diego, CA (US); Ryusuke Villemin, San Francisco, CA (US); Carl Magnus Wrenninge, San Francisco, CA (US)

(21) Appl. No.: 19/223,640

(22) Filed: May 30, 2025

Related U.S. Application Data
(60) Provisional application No. 63/738,080, filed on Dec. 23, 2024.

(51) Int. Cl. G06N 3/048; G06N 3/0495

(52) U.S. Cl. CPC G06N 3/048; G06N 3/0495

(57) ABSTRACT

Training and deploying a machine learning model in a low-latency runtime environment includes identifying a trained neural network including one or more parameters based on a specification of a pipeline element within a pipeline, the pipeline element corresponding to one or more operations executable by a central processing unit (CPU), the pipeline corresponding to a runtime environment having a low latency, the trained neural network generating a predicted output corresponding to a baseline output of the pipeline element in the runtime environment, sending an input associated with the pipeline to the trained neural network in the runtime environment, and generating the predicted output associated with the pipeline in the runtime environment based on the trained neural network, the trained neural network corresponding to one or more operations executable by the CPU.

### BACKGROUND

Many high performance applications are unable to leverage the power of machine learning techniques due to strict computational requirements. For example, most processes in high performance applications rely on numerous low-latency operations that are not conducive to a graphics processing unit (GPU)-based inference framework.

### SUMMARY

The present disclosure describes techniques for training and deploying a machine learning model enhancement of a pipeline element in a low-latency runtime environment using a central processing unit (CPU)-based inference framework. The machine learning model enhancement of the pipeline element may be optimized for fast and efficient inference in the low-latency runtime environment. A runtime environment having a low-latency may correspond to an execution environment that prioritizes minimal delay (latency) between receiving a request (e.g., from the moment an event is triggered) and generating a response (e.g., until a result is delivered). In one example, the low-latency runtime environment may correspond to a high-performance computing application. A pipeline element or a pipeline stage may refer to a single processing element in a pipeline of the high-performance computing application configured to receive an input and serve an output for another processing element, thereby creating a flow of data or instructions through the pipeline. The pipeline element may correspond to one or more low-latency operations executable by the CPU in the runtime environment.

The present disclosure relates to integrating advanced machine learning techniques into high-performance, low-latency runtime environments where memory constraints and latency requirements have limited the use of the advanced machine learning techniques. The present disclosure is particularly advantageous because the deployment of a trained machine learning model improves upon a baseline implementation of a pipeline element and reduces the memory footprint by orders of magnitude while significantly improving the quality of the output without sacrificing the computational performance in the low-latency runtime environment. The present disclosure provides the aforementioned technical effects and benefits by reducing the latency associated with invoking the machine learning model enhancement in the runtime environment through the use of an efficient CPU-based inference framework.

The use of the CPU-based inference framework avoids the overhead costs associated with the use of one or more GPUs to infer the machine learning model enhancement in the runtime environment. For example, in a cold-start, distributed computing environment, the overhead may be the non-negligible amount of warm-up time associated with the use of a GPU cluster for inference. In another example, the overhead may be associated with the high-frequency data transfers to and from the host device and the GPU cluster for inference. The CPU-based inference framework may include one or more efficient libraries to vectorize the learned mathematical calculations of the machine learning model enhancement (e.g., a trained neural network) at the time of inference. This vectorization has a technical effect in that it significantly reduces the number of instructions executable by one or more CPUs, reduces memory reads and cache misses in the runtime environment, thereby reducing the latency of inferring the machine learning model enhancement. Furthermore, the reduced latency of inferring the machine learning model enhancement can support a plurality of asynchronous threads running in parallel in the runtime environment, each asynchronous thread corresponding to a batch size of one or more input samples and independently invoking the machine learning model enhancement for generating a predicted output. An asynchronous thread may refer to a single thread corresponding to a batch size of one or more input samples that can invoke the machine learning model enhancement without waiting for other threads to be seeded with their corresponding input samples in the pipeline. As such, the present disclosure advantageously forgoes the GPU-based inference and instead facilitates the inference of the machine learning model enhancement to be frequent, independent, efficient, and exclusive to one or more CPUs in the runtime environment.

Furthermore, the present disclosure advantageously configures the machine learning model enhancement to include a number of parameters based on a specification of the pipeline element for training the machine learning model enhancement. The configuration of the number of parameters may be optimized based on the specification of the pipeline element and the machine learning model enhancement can be efficiently trained outside of the runtime environment (e.g., in an offline setting). In one example, a small number of nodes and layers may be selected for a neural network enhancement during the training phase. This advantageously offers a technical benefit of speeding up the computational performance and reducing the memory usage of the deployed neural network in the runtime environment compared to the baseline implementation of the pipeline element. In addition, the present disclosure dynamically generates ground truth data for training the machine learning model enhancement by directly calling a function associated with the pipeline element using a plurality of samples that are continuous up to and across a range of all or nearly all of the possible input data. This training approach advantageously generates a machine learning model that yields a more accurate, continuous fit across the range of the input data in the runtime environment, thereby improving the quality of the output relative to the baseline implementation. Furthermore, the present disclosure supports a periodic generation of new training data to further augment the training dataset and/or fully replace the training dataset every predetermined number of iterations. This training approach advantageously prevents the machine learning model from overfitting to a precomputed discrete set during iterative training.

The present disclosure relates to methods and systems for training and deploying one or more machine learning models in a low-latency runtime environment using a CPU-based inference framework. According to one aspect of the subject matter described in this disclosure, a method includes identifying a trained neural network including one or more parameters based on a specification of a pipeline element within a pipeline, the pipeline element corresponding to one or more operations executable by a CPU, the pipeline corresponding to a runtime environment having a low latency, the trained neural network generating a predicted output corresponding to a baseline output of the pipeline element in the runtime environment, sending an input associated with the pipeline to the trained neural network in the runtime environment, and generating the predicted output associated with the pipeline in the runtime environment based on the trained neural network, the trained neural network corresponding to one or more operations executable by the CPU.

In general, another aspect of the subject matter described in this disclosure includes a system comprising one or more processors and memory operably coupled with the one or more processors, wherein the memory stores instructions that, in response to the execution of the instructions by one or more processors, cause the one or more processors to perform operations. The operations include identifying a trained neural network including one or more parameters based on a specification of a pipeline element within a pipeline, the pipeline element corresponding to one or more operations executable by a CPU, the pipeline corresponding to a runtime environment having a low latency, the trained neural network generating a predicted output corresponding to a baseline output of the pipeline element in the runtime environment, sending an input associated with the pipeline to the trained neural network in the runtime environment, and generating the predicted output associated with the pipeline in the runtime environment based on the trained neural network, the trained neural network corresponding to one or more operations executable by the CPU.

Furthermore, in some implementations, the operations include determining a plurality of threads asynchronously invoking the trained neural network in the runtime environment, normalizing an input of the respective one of a plurality of threads before sending the input to the trained neural network in the runtime environment for a respective one of the plurality of threads asynchronously invoking the trained neural network in the runtime environment, and independently inferring the trained neural network based on the input of the respective one of the plurality of threads to generate a predicted output.

Moreover, in some implementations, a batch size of the input of the respective one of the plurality of threads includes one or more elements of data.

Also, in some implementations, the operations include sending the predicted output of the trained neural network to an input of another pipeline element within the pipeline in the runtime environment.

Also, in some implementations, the operations include converting one or more weights of the trained neural network into one or more static matrices, and at least partially replacing the pipeline element in the runtime environment with the trained neural network by importing the one or more static matrices into the runtime environment.

Moreover, in some implementations, the operations include inferring, using the one or more static matrices and one or more CPU-based libraries, the trained neural network as a series of matrix multiplication operations and parallelized activation function evaluations executable by the CPU.

Furthermore, in some implementations, the one or more CPU-based libraries enable vectorization of the series of matrix multiplication operations and the parallelized activation function evaluations executable by the CPU.

Moreover, in some implementations, the trained neural network is previously trained outside of the runtime environment using ground truth data associated with the pipeline element.

Also, in some implementations, the ground truth data associated with the pipeline element is dynamically generated based on querying a pre-computed data structure associated with the pipeline element using a plurality of samples of input data.

Moreover, in some implementations, the ground truth associated with the pipeline element is dynamically generated based on evaluating a quantitative model associated with the pipeline element using a plurality of samples of input data.

Furthermore, in some implementations, the specification of the pipeline element includes one or more inputs, one or more outputs, a memory size, and a measure of computational performance and the trained neural network is configured to include the one or more parameters subject to a constraint that a memory size of the neural network is lower and a measure of computational performance of the neural network is greater than that of the pipeline element for the one or more inputs and the one or more outputs.

Furthermore, in some implementations, the ground truth data associated with the pipeline element is fully regenerated every predetermined number of iterations.

Also, in some implementations, a cache of the ground truth data associated with the pipeline element is supplemented with new ground truth data every predetermined number of iterations, and the trained neural network is previously trained outside of the runtime environment based on sampling the cache of the ground truth data.

Furthermore, in some implementations, the pipeline includes a high-performance rendering application.

Also, in some implementations, the trained neural network in the runtime environment includes at least one from a group of a specular bidirectional reflectance distribution function compensation model and an atmospheric radiance evaluation model.

Moreover, in some implementations, the trained neural network includes a multilayer perceptron.

Other example aspects of the present disclosure are directed to other systems, methods, apparatuses, tangible non-transitory computer-readable media, and devices for performing functions described herein.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

These and other aspects and features of the present implementations will become apparent upon review of the following description of specific implementations in conjunction with the accompanying figures, wherein:

FIG. 1 is a block diagram illustrating an example hardware and software environment for integrating a CPU-based inference framework into a low-latency runtime environment of a high-performance application according to some implementations.

FIG. 2 is a block diagram illustrating an example computing system for integrating a CPU-based inference framework into a low-latency runtime environment of a high-performance application according to some implementations.

FIG. 3 is a flowchart illustrating a method for training and deploying a machine learning model enhancement in a low-latency runtime environment according to some implementations.

FIG. 4 is a flowchart illustrating a method for training a neural network for determining specular compensation according to some implementations.

FIG. 5 is a flowchart illustrating a method for training a neural network for determining radiance and transmittance information according to some implementations.

FIG. 6 is a flowchart illustrating a method for utilizing one or more neural networks for intra-rendering processes according to some implementations.

FIG. 7 is a graphical representation of an example renderer in a low-latency runtime environment according to some implementations.

FIGS. 8A-8B are graphical representations illustrating an example of a scene rendering and a performance comparison of a renderer according to some implementations.

FIGS. 9A-9B are graphical representations illustrating another example of a scene rendering and a performance comparison of a renderer according to some implementations.

FIGS. 10A-10B are graphical representations illustrating another example of a scene rendering and a performance comparison of a renderer according to some implementations.

FIGS. 11A-11B are graphical representations illustrating another example of a scene rendering and a performance comparison of a renderer according to some implementations.

FIGS. 12A-12B are graphical representations illustrating a performance of a renderer according to some implementations.

FIGS. 13A-13D are graphical representations illustrating example scenes rendered by a renderer according to some implementations.

FIGS. 14A-14B are graphical representations illustrating example rendered frames from a renderer according to some implementations.

FIGS. 15A-15B are graphical representations illustrating example rendered frames from a renderer according to some implementations.

### DETAILED DESCRIPTION

In general, large GPU-based clusters (e.g., thousands of machines) can run inferences on machine learning models in order to perform highly parallelized computations at once (e.g., concurrently) on a batch of input samples. Memory limitations aside, it may not be cost effective or feasible to switch the context to GPU-based clusters for inference in the runtime environment, especially when pipeline elements in the pipeline include one or more operations executable by a CPU and only a few elements of the pipeline can be appropriate to use machine learning models. For example, computations performed on the GPU-based clusters may cost roughly 10 to 100 times more than that of CPU-based clusters. Furthermore, the bus speeds of the low-latency runtime environment may not be able to support the high-frequency data transfers to and from the GPU-based cluster. Furthermore, the use of batching with a plurality of input samples for inference to amortize the costs of GPU-based clusters may not be feasible either because the values output by the machine learning models can frequently be in the critical path of other non-machine learning based elements in the pipeline. As such, the overhead costs of context switching to GPU-based clusters in the low-latency runtime environment decreases any benefit of using the machine learning models, such as neural networks.

In the following disclosure, a CPU-based inference framework may be implemented to train and deploy multiple machine learning models in a high-performance and low-latency runtime environment. The CPU-based inference framework facilitates the frequent, independent, and asynchronous use of one or more machine learning models for inference in the runtime environment. The CPU-based framework facilitates the training of a machine learning model enhancement to improve upon a baseline implementation of a corresponding element or stage of a pipeline. The machine learning model enhancement of the pipeline element may partially or fully replace a functionality of the pipeline element in the low-latency runtime environment. For example, the low-latency runtime environment may include real-time video and/or audio streaming and communication, real-time weather monitoring, online gaming platforms, content delivery networks, financial trading systems, real-time fraud detection systems, real-time sensor analysis in autonomous driving platforms, etc. The machine learning model enhancement significantly improves the quality of the results and reduces memory footprint by orders of magnitude without sacrificing speed when compared to the non-machine learning baseline implementation of the corresponding element in the pipeline. For example, the CPU-based inference framework may enable the inference of the machine learning model enhancement to be exclusively performed on one or more CPUs in low-latency settings of the runtime environment independent of any GPU or GPU cluster. The CPU-based inference framework may use one or more CPU-based libraries to efficiently perform the learned computations of a neural network enhancement on the CPU cluster in the runtime environment. For example, one or more efficient libraries may vectorize the learned mathematical calculations of the machine learning model enhancement at the time of inference. As such, the latency associated with inferring the machine learning model enhancement in the runtime environment may be reduced. This reduced latency of inferring the machine learning model enhancement offers a technical improvement in terms of supporting a plurality of asynchronous threads to run in parallel in the runtime environment, where each asynchronous thread corresponding to a batch size of one or more input samples can independently invoke the machine learning model enhancement and generate a predicted output without having to be batched with other threads of the pipeline.

In an aspect, as an example, the present disclosure describes the implementation of the CPU-based inference framework in a visual effects (VFX) rendering pipeline that may benefit from an application of machine learning techniques to one or more intra-rendering processes. During rendering, there may be several computations that are performed at per bounce of the sampled light (e.g., sample bounce) in a three-dimensional (3D) scene including bidirectional reflectance distribution function (BRDF) approximation and light source sampling and evaluation. A trained neural network may be used to perform such computations to improve the convergence and quality of a rendered image. However, making use of the GPU-cluster for inferring the neural network may not take into account the computational budget of the runtime environment of the rendering pipeline. During rendering, each sample bounce in the three-dimensional scene may wait for the value output by the neural network before it can proceed with its remaining computations (e.g., other non-machine learning tasks) and the subsequent bounce. Furthermore, during rendering, the sample bounces may be sent to the rendering pipeline for computations at various pixels and threads asynchronously. Therefore, it may not be cost-effective to switch the context to the GPU-based cluster for inference of the neural network in the low-latency runtime environment of the rendering pipeline. For example, one inference strategy to stall the rendering process, by syncing the sample bounce data for executing batched evaluations that amortize the GPU computational costs, decreases any benefit of using the neural network in the rendering process, because more sample bounces may be rendered in that time.

The technical solutions according to the present disclosure are particularly advantageous because they take into account the computational budget corresponding to the low-latency runtime environment of the rendering pipeline and provide at least a system and method for implementing a CPU-based inference framework that facilitates the inference of useful neural network models independently, efficiently, frequently, and exclusively on one or more CPUs in the low-latency runtime environment.

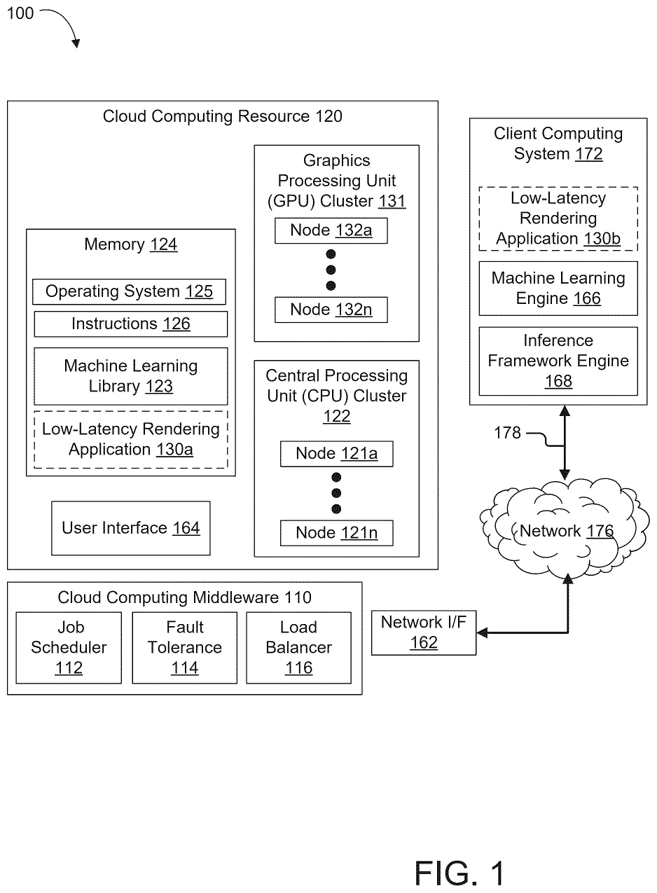

FIG. 1 illustrates an example hardware and software environment 100 for integrating a CPU-based inference framework into a low-latency runtime environment of a high-performance application within which various techniques disclosed herein may be implemented. The environment 100, for example, may include a cloud computing resource 120, a cloud computing middleware 110, a client computing system 172, a network 176, and a network interface 162. In FIG. 1 and the remaining figures, like numbers denote like parts throughout the several views and a letter after a reference number, e.g., “130a,” represents a reference to the element having that particular reference number. A reference number in the text without a following letter, e.g., “130,” represents a general reference to instances of the element bearing that reference number.

In the illustrated implementation, full or partial machine learning-based training and inference is implemented in the cloud computing resource 120, which may include one or more CPU clusters 122, one or more GPU clusters 131, and one or more memories 124, with one or more of the nodes 121 within the CPU cluster 122 and/or one or more of the nodes 132 within the GPU cluster 131 configured to execute program code instructions 126 stored in a memory 124. Each memory 124 may also include an operation system 125, a machine learning library 123 configured for training one or more machine learning models, and optionally a low-latency rendering application 130a configured to infer the trained machine learning models for performing one or more of their functionalities as described herein. The cloud computing resource 120 may be configured to deliver computing assets over the Internet via the network 176 to a client computing system 172. For example, the computing assets may include storage, processing power, databases, networking, analytics, artificial intelligence and machine learning, software applications, etc. The cloud computing resource 120 may be implemented as any number of different types of cloud computing system, including software-as-a-service (SaaS), serverless computing, hybrid cloud computing, and/or private cloud computing, and it will be appreciated that the configuration of the aforementioned components 122, 124, and 130 may vary widely based upon the type of cloud computing system within which these components are utilized.

In some implementations, the cloud computing resource 120 may also include a cloud computing middleware 110, which may serve as an interface between a client computing system 172 and the cloud computing resource 120 so that the users of the client computing system 172 may treat the cloud computing resource 120 as one cohesive computing unit, for example, via a single system image concept. The cloud computing middleware 110 may include a job scheduler 112 configured for scheduling a job and finding a distribution of eligible nodes for the job based on priorities and resource requirements associated with the job, a fault tolerance 114 mechanism configured for fault detection and handling the fault appropriately to prevent service loss, and a load balancer 116 configured for distributing the network load or application traffic across the clusters 122/131 to improve performance and reliability.

In general, different architectures, including various combinations of software, hardware, circuit logic, sensors, networks, etc. may be used to implement the cloud computing resource 120, the client computing system 172 and various other components illustrated in FIG. 1. Each processor in the node 121/132 may be implemented, for example, as a microprocessor and each memory may represent the random access memory (“RAM”) devices comprising a main storage, as well as any supplemental levels of memory, e.g., cache memories, non-volatile or backup memories (e.g., programmable or flash memories), read-only memories, etc. In addition, each memory 124 may be considered to include memory storage physically located elsewhere in the cloud computing resource 120, e.g., any cache memory in a processor, as well as any storage capacity used as a virtual memory, e.g., as stored on a mass storage device or another computer controller. In addition, for additional storage, the cloud computing resource 120 may include one or more mass storage devices, e.g., a removable disk drive, a hard disk drive, a direct access storage device (“DASD”), an optical drive (e.g., a CD drive, a DVD drive, etc.), a solid state storage drive (“SSD”), network attached storage, a storage area network, and/or a tape drive, among others. Furthermore, the cloud computing resource 120 may include a user interface 164 to enable the cloud computing resource 120 to receive a number of inputs from and generate outputs for a user or operator, e.g., one or more displays, touchscreens, voice and/or gesture interfaces, buttons and other tactile controls, etc. Otherwise, user input may be received via another computer or electronic device, e.g., via an app on a mobile device or via a web interface.

It will be appreciated that the collection of components illustrated in FIG. 1 for the cloud computing resource 120 is merely one example. Individual clusters may be omitted in some implementations. Additionally, or alternatively, in some implementations, multiple clusters of the same types illustrated in FIG. 1 may be used for redundancy and/or to cover different data pipelines in an offline and/or runtime environment. Moreover, there may be additional subsystems beyond those described above to support the operation of the cloud computing resource 120. Further, it will be appreciated that in some implementations, some or all of the functionality of a subsystem may be implemented with program code instructions 126 resident in one or more memories 124 and executed by one or more processors in the nodes 121/132, and that these additional subsystems may in some instances be implemented using the same processor(s) and/or memory. Subsystems may be implemented at least in part using various dedicated circuit logic, various processors, various field programmable gate arrays (“FPGA”), various application-specific integrated circuits (“ASIC”), various real time controllers, and the like, as noted above, multiple subsystems may utilize circuitry, processors, sensors, and/or other components. Further, the various components in the cloud computing resource 120 may be networked in various manners.

Moreover, the cloud computing resource 120 may include one or more network interfaces, e.g., network interface 162, suitable for communicating with one or more networks 176 to permit the communication of information with other computers and electronic devices, including, for example, a central service, such as another cloud service, from which the cloud computing resource 120 receives information including machine learning models and other training data for use in training and inference thereof. The one or more networks 176, for example, may be a communication network that includes a wide area network (“WAN”) such as the Internet, one or more local area networks (“LANs”) such as Wi-Fi LANs, mesh networks, etc., and one or more bus subsystems. The one or more networks 176 may optionally utilize one or more standard communication technologies, protocols, and/or inter-process communication techniques.

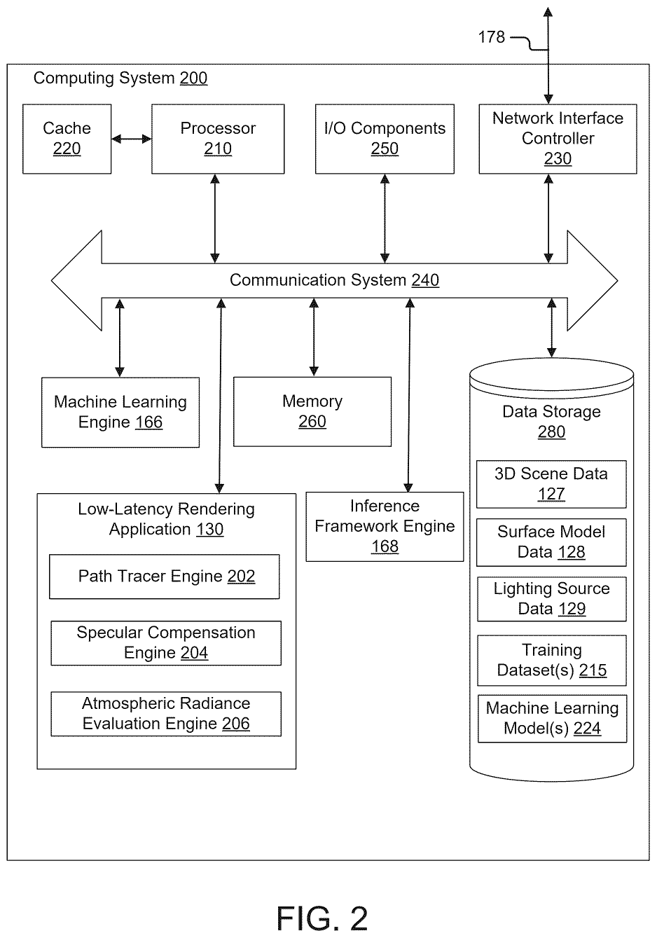

In the illustrated implementation, the cloud computing resource 120 may communicate via the network 176 with the client computing device 172 for the purposes of implementing various functions described below for training and deploying multiple machine learning models in a low-latency runtime environment using CPU-based inference. In some implementations, the data output by the CPU cluster 122 can be forwarded to the low-latency application 130b on the client computing system 172 via the network 176 for additional processing. In some implementations, client computing device 172 may be a cloud-based computing device. The client computing device 172 includes a low-latency rendering application 130b, a machine learning engine 166, and an inference framework engine 168. As depicted in FIG. 1, the low-latency rendering application 130a and 130b is shown in dotted lines to indicate that the operations performed by the low-latency rendering application 130a and 130b as described herein may be performed at the cloud computing resource 120, the client computing device 172, or a combination thereof. In some implementations, each instance 130a and 130b may include one or more components of the low-latency rendering application 130 depicted in FIG. 2, and may be configured to fully or partially perform the functionalities described herein depending on where the instance resides. For example, the low-latency rendering application 130 may be a thin-client application with some functionality executed on the cloud computing resource 120 and additional functionality executed on the client computing device 172.

The present disclosure details an implementation of a CPU-based inference framework for computer graphics, as an example. The pipeline corresponding to the low-latency rendering application 130 may include elements for geometry processing, shading, and rasterization. For example, the rendering pipeline may be used to generate realistic VFX data in the context of autonomous vehicle simulation and development where the deployment of the CPU-based inference framework increases the accuracy and efficiency of the autonomous vehicle simulation itself. The present disclosure describes the deployment of machine learning models as enhancements of two intra-rendering processes in the shading stage of the rendering pipeline, namely, specular BRDF compensation and atmospheric radiance evaluation.

The CPU-based inference framework herein may be deployed in other elements of the rendering pipeline and general pipelines of other specific use cases where, for example, ready access to GPUs is limited. There are many low-latency applications in other pipelines that can utilize the power of machine learning with CPU-based inference framework. For example, a utility management system may employ neural networks for real-time energy consumption prediction in microgrids, a high-frequency trading system may process stock market data using deep neural networks to facilitate rapid trading decisions, a fraud detection system may rely on neural networks to monitor and flag suspicious transactions in real time, an equipment management system may utilize neural networks for predictive maintenance where sensor data is analyzed to predict equipment failures, a healthcare system may use neural networks to support real-time diagnostics and patient monitoring, an air quality prediction system may use neural networks to predict extreme weather events and monitor pollution levels in real time, the field of astrophysics may also benefit from neural networks in real-time data analysis, where the system processes massive datasets from telescopes to detect cosmic events, a signal processing system on a smartphone may use neural network to handle real-world signals, such as audio, video, sensor data, etc, and manipulating them digitally to enhance quality and improve communication, etc.

Each processor in the node 121/132 illustrated in FIG. 1, as well as various additional controllers and subsystems disclosed herein, generally operates under the control of an operating system 125 and executes or otherwise relies upon various computer software applications, components, programs, objects, modules, data structures, etc., as will be described in greater detail below. Moreover, various applications, components, programs, objects, modules, etc. may also execute on one or more processors in another computer (e.g., computing system 172) coupled to cloud computing resource via network 176, e.g., in a distributed, cloud-based, or client-server computing environment, whereby the processing required to implement the functions of a computer program may be allocated to multiple computers and/or services over a network.

In general, the routines executed to implement the various implementations described herein, whether implemented as part of an operating system 125 or a specific application, component, program, object, module or sequence of instructions, or even a subset thereof, will be referred to herein as “program code.” Program code typically comprises one or more instructions that are resident at various times in various memory and storage devices, and that, when read and executed by one or more processors, perform the steps necessary to execute steps or elements embodying the various aspects of the present disclosure. Moreover, while implementations have and hereinafter will be described in the context of fully functioning computers and systems, it will be appreciated that the various implementations described herein are capable of being distributed as a program product in a variety of forms, and that implementations can be implemented regardless of the particular type of computer readable media used to actually carry out the distribution.

Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.) among others.

In addition, various program codes described hereinafter may be identified based upon the application within which it is implemented in a specific implementation. However, it should be appreciated that any particular program nomenclature that follows is used merely for convenience, and thus the present disclosure should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the present disclosure is not limited to the specific organization and allocation of program functionality described herein.

The example environment illustrated in FIG. 1 is not intended to limit implementations disclosed herein. Indeed, other alternative hardware and/or software environments may be used without departing from the scope of implementations disclosed herein.

FIG. 2 is a block diagram illustrating an example of a computing system 200 for integrating a CPU-based inference framework into a low-latency runtime environment of a high performance application according to some implementations. For example, a rendering application may be a high-performance application having a low-latency runtime environment. The computing system 200 may be representative of the cloud computing resource 120, the client computing system 172, or a combination thereof.

Referring to FIG. 2, the illustrated example computing system 200 includes one or more processors 210 in communication, via a communication system 240 (e.g., bus), with memory 260, at least one network interface controller 230 with network interface port for connection to a network (e.g., network 176 via signal line 178), a data storage 280, and other components, e.g., an input/output (“I/O”) components interface 250 connecting to a display (not illustrated) and an input device (not illustrated), a rendering application 130, an inference framework engine 168, and a machine learning engine 166. Generally, the processor(s) 210 will execute instructions (or computer programs) received from memory 260. The processor(s) 210 illustrated incorporate, or are directly connected to, cache memory 220. In some instances, instructions are read from memory 260 into the cache memory 220 and executed by the processor(s) 210 from the cache memory 220.

In more detail, the processor(s) 210 may be any logic circuitry that processes instructions, e.g., instructions fetched from the memory 260 or cache 220. In some implementations, the processor(s) 210 are microprocessor units or special purpose processors. The computing device 172 may be based on any processor, or set of processors, capable of operating as described herein. The processor(s) 210 may be a single core or multi-core processor(s). The processor(s) 210 may be multiple distinct processors.

The memory 260 may be any device suitable for storing computer readable data. The memory 260 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 200 may have any number of memory devices as the memory 260. While the rendering application 130, the inference framework engine 168, and the machine learning engine 166 are illustrated as being separate from processor 210 and memory 260, it will be appreciated that in some implementations, some or all of the functionality of the components 130, 166, and 168 may be implemented with program code instructions resident in the memory 260 and executed by the processor 210.

The cache memory 220 is generally a form of computer memory placed in close proximity to the processor(s) 210 for fast read times. In some implementations, the cache memory 220 is part of, or on the same chip as, the processor(s) 210. In some implementations, there are multiple levels of cache 220, e.g., L2 and L3 cache layers.

The network interface controller 230 manages data exchanges via the network interface (sometimes referred to as network interface ports). The network interface controller 230 handles the physical and data link layers of the OSI model for network communication. In some implementations, some of the network interface controller's tasks are handled by one or more of the processors 210. In some implementations, the network interface controller 230 is part of a processor 210. In some implementations, a computing system 200 has multiple network interfaces controlled by a single controller 230. In some implementations, a computing system 200 has multiple network interface controllers 230. In some implementations, each network interface is a connection point for a physical network link (e.g., a cat-5 Ethernet link). In some implementations, the network interface controller 230 supports wireless network connections and an interface port is a wireless (e.g., radio) receiver/transmitter (e.g., for any of the IEEE 802.11 protocols, near field communication “NFC”, Bluetooth, ANT, WiMAX, 5G, or any other wireless protocol). In some implementations, the network interface controller 230 implements one or more network protocols such as Ethernet. Generally, a computing device 200 exchanges data with other computing devices via physical or wireless links (represented by signal line 178) through a network interface. The network interface may link directly to another device or to another device via an intermediary device, e.g., a network device such as a hub, a bridge, a switch, or a router, connecting the computing device 200 to a data network such as the Internet.

The data storage 280 may be a non-transitory storage device that stores data for providing the functionality described herein. The data storage 280 may store, among other data, 3D scene data 127, surface model data 128, lighting source data 129, training dataset 215, and a machine learning model or representation 224, as will be defined below.

The computing system 200 may include, or provide interfaces for, one or more input or output (“I/O”) devices 250. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers. Other components may include an I/O interface, external serial device ports, and any additional co-processors. For example, a computing system 200 may include an interface (e.g., a universal serial bus (USB) interface) for connecting input devices, output devices, or additional memory devices (e.g., portable flash drive or external media drive). In some implementations, a computing device 200 includes an additional device such as a co-processor, e.g., a math co-processor can assist the processor 210 with high precision or complex calculations.

In implementations consistent with the disclosure, the inference framework engine 168 may include software and/or logic to facilitate training and deploying a machine learning model enhancement of a pipeline element in a low-latency runtime environment. The machine learning model enhancement improves upon the baseline implementation of the pipeline element in the low-latency runtime environment. The machine learning model enhancement may partially or fully replace a functionality of the pipeline element in the low-latency runtime environment. The objective of the inference framework engine 168 is to reduce the latency associated with inferring the trained machine learning algorithms in a low-latency runtime environment by implementing a fast CPU-based inference framework while significantly improving performance and reducing memory costs when compared to the non-machine learning baseline implementation of the pipeline element. The inference framework engine 168 prioritizes the CPU-based inference framework because of the computational budget (e.g., hardware constraints) of the runtime environment and the need for efficient processing where the overhead of using a GPU-based inference framework is prohibitive. In some implementations, the inference framework engine 168 facilitates an inference of advanced machine learning algorithms (e.g., a neural network) in a low-latency runtime environment of an application.

In implementations consistent with the disclosure, the low-latency rendering application 130 can be utilized to perform computations at the per sample bounce level including BRDF approximation and light source sampling and evaluation during rendering. More specifically, the present disclosure is directed to inferring multiple neural networks independently, efficiently, and frequently using CPU-based inference framework to improve convergence and quality of a synthesized image during rendering. In some implementations, the low-latency rendering application 130 includes a path tracer engine 202, a specular compensation engine 204, and an atmospheric radiance evaluation engine 206. The path tracer engine 202, the specular compensation engine 204 and the atmospheric radiance evaluation engine 206 of the low-latency rendering application 130 and separately the machine learning engine 166 and the inference framework engine 168 are example components in which the techniques described herein may be implemented and/or with which systems, components, and techniques described herein may interface. While described in the context of the computing system 200, it should be understood that the operations performed by the one or more components 202, 204, 206, 166, and 168 of FIG. 2 may be distributed across multiple computing systems. In some implementations, one or more aspects of components 202, 204, 206, 166, and 168 may be combined into a single system and/or one or more aspects may be implemented by the computing system 200. For example, in some implementations, aspects of the inference framework engine 168 may be combined with aspects of the machine learning engine 166. In another example, aspects of the path tracer engine 202 may be combined with aspects of either the specular compensation engine 204 or the atmospheric radiance evaluation engine 206. Engines in accordance with many implementations may each be implemented in one or more computing devices that communicate, for example, through the communication network 176.

The inference framework engine 168 identifies a pipeline element in a low-latency runtime environment. For example, the pipeline element may refer to a single processing stage of a pipeline corresponding to a high-performance computing application. The pipeline element may correspond to one or more low-latency operations executable by one or more CPUs in the runtime environment. The inference framework engine 168 benchmarks a target application in its runtime environment where the use of machine learning may be beneficial. For example, the inference framework engine 168 may benchmark the target application by running one or more tests to measure aspects of the target application, such as speed, efficiency, stability, scalability, etc, and identify areas to improve with machine learning techniques for performance optimization. The inference framework engine 168 evaluates a set of constraints for deploying a machine learning-based enhancement of the pipeline element in the low-latency runtime environment. The set of constraints defining the deployment of the machine learning-based enhancement in a runtime environment of a pipeline may include that (a) the one or more operations corresponding to the inference of the machine learning-based enhancement execute on the CPU, that (b) the execution of the one or more operations on the CPU be efficient when the machine learning-based enhancement can be asynchronously called multiple times (e.g., each asynchronous call to the machine learning model for inference may include a single-element batch of unique input data) in the low-latency runtime environment, and that (c) the machine learning-based enhancement be an improvement over the baseline implementation of the pipeline element. For example, the inference framework engine 168 may identify intra-rendering processes, such as specular BRDF compensation and atmospheric model evaluation in a rendering application for enhancement with a corresponding neural network.

The inference framework engine 168 determines a specification of the pipeline element. The inference framework engine 168 can determine one or more inputs, one or more outputs, a memory size, and a measure of computational performance of the pipeline element. For example, the memory size may refer to the amount of RAM space (measured in bytes, kilobytes, megabytes, or gigabytes) that the pipeline element uses while it is running, including its code, data, and stack in its non-machine learning baseline implementation. In another example, the measure of computational performance may include a calculation of floating point operations per second (FLOPS) of the pipeline element in its non-machine learning baseline implementation.

The inference framework engine 168 configures a machine learning model to include one or more parameters based on the specification. For example, the inference framework engine 168 may configure one or more parameters of a multilayer perceptron (MLP) neural network in terms of its size, such as a number of layers, a number of nodes, layer width, etc. based on the specification of the pipeline element. In some implementations, the ‘right’ size or the number of parameters of the machine learning model enhancement of the pipeline element may be based on back-of-the-envelope calculations of the FLOPS of the baseline pipeline element. In other implementations, the one or more parameters of the machine learning model enhancement may be based on a size of a pre-computed data structure used by the pipeline element and a desired compression factor. The pre-computed data structure may be used for approximating the mathematical computations at runtime. For example, the pre-computed data structure may be a table or an array storing a plurality of key-value pairs. The inference framework engine 168 determines one or more parameters of the machine learning model subject to a constraint that a memory size of the machine learning model is lower and a measure of computational performance of the machine learning model is greater than that of the baseline implementation of the pipeline element for a predetermined (e.g., an equivalent) number of inputs and outputs. In one example, the constraint may define an operational budget associated with deploying the machine learning model enhancement for efficient inference of single-element batches of unique input data from a multitude of asynchronous threads executing in parallel in the runtime environment. The objective for using the machine learning model enhancement may be for the machine learning model enhancement to use fewer FLOPS and/or take up less space in memory than the baseline pipeline element for speedup to happen in the low-latency runtime environment.

The inference framework engine 168 trains the machine learning model using ground truth data associated with the pipeline element. The inference framework engine 168 cooperates with the machine learning engine 166 to dynamically generate ground truth data and train the machine learning model. In some implementations, the inference framework engine 168 may determine a quantitative or mathematical model associated with the computational operations of the pipeline element in its baseline implementation. For example, the mathematical model may include a precise algorithm or equation for image rendering. The mathematical model can be computationally expensive to evaluate in real-time in the low-latency runtime environment due to high computational complexity. For example, the evaluation of the mathematical model may involve solving complex integrals, include iterative methods, etc. A goal of the inference framework engine 168 may be to avoid directly evaluating the mathematical model in the low-latency runtime environment by training and deploying a fast machine learning model enhancement instead. Instead of precomputing a fixed dataset for training, the inference framework engine 168 may evaluate the mathematical model as needed using a plurality of samples of input data and dynamically generate accurate output data on the fly. These dynamically generated output data may serve as ground truth data to use as training targets for the machine learning model enhancement. For example, the inference framework engine 168 may train the machine learning model enhancement to map the plurality of samples of input data to these dynamically generated output data. An advantage of dynamically generating the ground truth data may be that the machine learning model enhancement can be trained to learn the full input space or range and not just a precomputed subset. The inference framework engine 168 may train the machine learning model to be an approximation of the mathematical model. For example, the trained machine learning model may provide fast, approximate output for any input, mimicking the mathematical model's behavior. In some implementations, the mathematical model itself may be intractable to evaluate for some reason but an approximate function may be available to represent the mathematical model. The inference framework engine 168 may train the machine learning model to replay the approximate function.

The inference framework engine 168 may determine a pre-computed data structure associated with the computational operations of the pipeline element. The pre-computed data structure may be of a fixed resolution and used by the pipeline element in place of the mathematical model. For example, the data structure may include a precomputed table of input-output pairs for runtime access by the pipeline element. The pre-computed data structure may be parameterized across a number of inputs to yield an approximate output as an alternative to complex computations during runtime. Another goal of the inference framework engine 168 may be to avoid the memory constraints of storing the pre-computed data structure in the low-latency runtime environment by training and deploying a fast machine learning model enhancement instead. The inference framework engine 168 may query the pre-computed data structure as needed using a plurality of samples of input data to access the corresponding output values from the data structure to use as ground truth data for training the machine learning model enhancement. The plurality of samples of input data may be dynamically generated to be continuous up to and across a range or domain of all or nearly all of the possible input data for obtaining the ground truth data from the pre-computed data structure. The inference framework engine 168 may train the machine learning model to be an approximation of the pre-computed data structure used by the pipeline element. For example, the trained machine learning model may provide a continuous fit by mitigating the interpolation inaccuracies of the pre-computed data structure by generating output approximations for values between the samples of the pre-computed data structure, thereby balancing accuracy and performance.

The plurality of samples of input data used by the inference framework engine 168 for generating ground truth data may be varied and continuous up to and across a range of all or nearly all of the possible input data that the machine learning model can encounter upon its deployment to production. The training of the machine learning model by the inference framework engine 168 may be performed offline (i.e., outside of the deployed runtime environment) to determine weights and biases. In some implementations, the inference framework engine 168 may regenerate the ground truth data every predetermined number of iterations to continuously train the machine learning model. The constant generation of new ground truth data prevents the machine learning model from overfitting to a precomputed discrete set and thereby enables smooth interpolation. In some implementations, the inference framework engine 168 may generate new ground truth data for adding to a cache of ground truth data every predetermined number of iterations. The inference framework engine 168 samples the cache of ground truth data to retrain the machine learning model.

The inference framework engine 168 replaces the pipeline element in the low-latency runtime environment with the trained machine learning model. After the training is terminated, the inference framework engine 168 may ‘freeze’ or secure the network weights of the machine learning model to prevent updates. The inference framework engine 168 may convert the network weights of the machine learning model into one or more static matrices and import the static matrices into the low-latency runtime environment of the application. For example, the inference framework engine 168 may deploy the machine learning model as one or more static weight matrices in a C++ runtime environment. The network weights of the machine learning model may be considerably smaller compared to a size of the fixed-resolution, pre-computed data structure associated with the baseline implementation of the pipeline element that they are replacing in the memory. This provides a technical improvement by significantly freeing up memory space in the low-latency runtime environment that may be used more effectively for further speeding up the computational performance. For example, a rendering pipeline replacing some intra-rendering processes may benefit from freeing up memory space for producing more realistic geometry or creating more realistic textures in the rendered scene. The latency of inferring the machine learning model in the runtime environment may be considerably lower than evaluating a quantitative model associated with the baseline implementation of the pipeline element or accessing a fixed-resolution, pre-computed data structure approximating the quantitative model. This provides another technical improvement where a plurality of inference calls to the machine learning model can be asynchronous in the runtime environment and the machine learning model may independently and efficiently generate an output for the plurality of inference calls. An inference call may correspond to a batch size including one or more samples of unique input data and invoke the machine learning model without waiting for batching with other inference calls.

The inference framework engine 168 sends an input associated with the pipeline to the trained machine learning model in the low-latency runtime environment for inference. The pipeline may use multithreading to parallelize computations. The inference framework engine 168 may identify a plurality of threads in the low-latency runtime environment of the pipeline during execution. The inference framework engine 168 may avoid batching the input data associated with the plurality of threads for inference as it can cause a slowdown in the execution of the pipeline. Instead, each thread of a plurality of threads may asynchronously invoke one or more trained machine learning model enhancements of the pipeline in the low-latency runtime environment. For each thread asynchronously invoking the trained machine learning model in the low-latency runtime environment, the inference framework engine 168 may infer the trained machine learning model independently and exclusively using one or more CPUs. In some implementations, the inference framework engine 168 normalizes the input of each thread before sending it to the trained machine learning model for inference. The inference framework engine 168 deploys the trained machine learning model for inference using the one or more imported static matrices and one or more CPU-based libraries. For example, the inference framework engine 168 performs a series of matrix multiplication operations and applies activation functions in parallel across the layers of the trained machine learning model on the CPU-cluster using the one or more static matrices and the one or more CPU-based libraries.

The use of the one or more CPU-based libraries by the inference framework engine 168 enables vectorization of the series of matrix multiplication operations and the activation functions applied in parallel across the layers of the trained machine learning model. Vectorization creates ‘vectorized’ code from scalar code enabling operations to be performed on entire arrays or vectors at once, instead of individual elements within those arrays. This vectorization offers a technical improvement corresponding to significantly reducing the number of instructions executable by one or more CPUs, reducing memory reads and cache misses in the runtime environment, thereby forgoing the expensive GPU-based inference of the trained machine learning model in the low-latency runtime environment. In other words, the technical improvement may correspond to reducing the latency associated with inferring the trained machine learning model on one or more CPUs. Furthermore, the reduced latency of inferring the machine learning model can support a plurality of asynchronous threads running in parallel in the runtime environment, each asynchronous thread corresponding to a batch size of one or more input samples and independently invoking the machine learning model for generating a predicted output using the one or more CPUs. Advantageously, the CPU-based inference framework does not incur the costs of high-frequency data transfers to and from the host device corresponding to the runtime environment and the GPU clusters. By associating the execution of one or more operations corresponding to the inference of the machine learning model exclusively to the CPU clusters, the CPU-based inference framework also bypasses the warm-up time of the GPU clusters. For example, after being idle, a GPU cluster may need a warm-up time of a few minutes to reach an optimal operating temperature for stable performance, which can be a non-negligible hindrance especially in a cold-start, distributed computing environment.

The inference framework engine 168 generates a predicted output associated with the pipeline in the low-latency runtime environment based on the trained machine learning model. In some implementations, the pipeline element may be a subprocess of the pipeline in the low-latency runtime environment. For example, the intra-rendering processes, such as specular BRDF compensation process and atmospheric radiance evaluation process may be each be a subprocess of the rendering pipeline. The inference framework engine 168 returns the predicted output of the trained neural network for each thread asynchronously invoking the trained neural network to an input of another pipeline element in the low-latency runtime environment of the application. Each thread may use the output of the trained machine learning model before it can proceed with its remaining computations in the low-latency runtime environment.

The path tracer engine 202 may include software and/or logic for implementing a CPU-based path tracer in a rendering pipeline. In some implementations, the path tracer may be an offline path tracer. The path tracer engine 202 may receive VFX data including 3D scene data 127 in the rendering pipeline and generate a high-quality, photo-realistic image by simulating a path of light through the 3D scene using path tracing. The 3D scene data 127 may include surface model data 128 of one or more objects and lighting source data 129 of direct and indirect lighting sources. The path tracer engine 202 may cooperate with the specular compensation engine 204 and the atmospheric radiance evaluation engine 206 to perform complex calculations for the rendering. For example, each of the specular compensation engine 204 and the atmospheric radiance evaluation engine 206 may integrate one or more lightweight multilayer perceptron (MLP) neural networks into the rendering pipeline for performing their functionalities. The path tracer engine 202 may utilize parallel computing power offered by the CPU cluster 122 in the cloud computing resource 120 for rendering with multiple threads working simultaneously and asynchronously. During path tracing, the path tracer engine 202 uses each thread to asynchronously determine the irradiance contributions across a pixel by sampling the light transport in the 3D scene. The irradiance contributions may represent the amount of light reaching a surface from all directions in the 3D scene. Each pixel's convergence during the rendering can be based on the irradiance contributions determined from multiple samples as the path of light bounces or reflects a number of times through the 3D scene. The determination of irradiance contributions for these samples may include multiple steps, such as determining the material response and the environmental light contribution at every bounce of light in the 3D scene. The path tracer engine 202 cooperates with the specular compensation engine 204 and the atmospheric radiance evaluation engine 206 to determine the material response and the environmental light contribution respectively at every bounce of light in the 3D scene.

The specular compensation engine 204 may include software and/or logic for determining a compensation factor α to apply to a specular BRDF model to address the energy loss occurring in rendering. A BRDF model describes how light may be reflected off a surface in a rendered scene. The specular component of the BRDF model represents mirror-like reflections on smooth surfaces. Specular BRDF models, including those used in rendering, may fail to preserve energy across one or more of material parameters (e.g., roughness) and viewing angles. For example, specular BRDF models can fail to account for all the energy received by a material, especially with rough surfaces due to the single-scattering assumption that micro facet models rely on. A multiple-scattering BRDF model may mitigate this issue with single-scattering specular BRDF model. However, this switch to the multiple-scattering BRDF model adds significant computational overhead to the rendering process. Instead to preserve the energy in the more-efficient, single scattering specular BRDF model, the specular compensation engine 204 may determine the compensation factor α to offset the loss by applying the compensation factor α to the specific BRDF model.

An example quantitative or mathematical model of the specular compensation factor α is below:

$$α ( {ω}_{0} , {ω}_{i} ) = \frac{( 1 - {E}_{{ω}_{0}} ) ( 1 - {E}_{{ω}_{i}} )}{( 1 - {E}_{avg} )} ,$$

where E_{ω}_{ₒ} and E_{ω}_{ᵢ} are the energies reflected in the outgoing and incoming directions respectively, and E_{avg} is the cosine-weighted average of E. For ease of notation, ω refers to the cosine-weighted direction. Furthermore, E_{ω}_{ₒ} is defined as shown below:

$${E}_{{ω}_{0}} = {\int }_{0}^{2 π} {\int }_{0}^{1} f ( {ω}_{0} , {ω}_{i} , ∅ ) d {ω}_{i} d ∅ ,$$

which integrates the BRDF, f, over the hemisphere of incoming directions. Lastly, the average energy, E_{avg}, integrates over all outgoing directions as shown below:

$${E}_{avg} = 2 {\int }_{0}^{1} {E}_{ω} ω d ω$$

Since E involves a double integral for each direction and E_{avg} involves a triple integral, this mathematical model for the specular compensation factor can be far too expensive to compute dynamically during rendering.

A precomputed data structure corresponding to the above mathematical model may be built for use during rendering in a baseline implementation. For example, the precomputed data structure can be parameterized across viewing angles and BRDF parameters to yield the appropriate compensation factor α at each sample bounce of light during rendering. However, there may be an undesirable trade-off with the resolution of the precomputed data structure in the low-latency runtime environment, namely, a larger memory footprint may be needed at more granular resolutions of the pre-computed data structure and a reduced model accuracy may be returned at coarser resolutions of the pre-computed data structure. In some implementations, the precomputed data structure corresponding to the mathematical model for the specular compensation factor may be stored in the surface model data 128 in the data storage 280.

In some implementations, the specular compensation engine 204 cooperates with the machine learning engine 166 and inference framework engine 168 to train and deploy a machine learning model 224 (e.g., non-linear neural network) as an enhancement that uses the CPU-based inference framework as described herein to determine the specular compensation factor in the low-latency runtime environment. For example, the specular compensation engine 204 generates a multilayer perceptron (MLP) neural network for determining a specular compensation factor. The MLP neural network may take the incoming and outgoing directions as input and estimate the corresponding compensation factor, α, as output which can be applied to the corresponding specular BRDF model. The specular compensation engine 204 may train a separate neural network enhancement for each specular BRDF model. In one example, the specular BRDF model may correspond to the GGX (“Ground Glass with unknown distribution”) model, also known as Trowbridge-Reitz distribution. The GGX model may refer to a microfacet distribution model that provides realistic, physically accurate specular highlights for rough surfaces in computer graphics. In another example, the specular BRDF model may be the ABC model. The ABC model may refer to a reflectance model with three tunable parameters (A, B, C) used to accurately describe the reflectance properties of glossy and optically smooth surfaces. The parameter A may be related to the overall reflectance or amplitude. The parameter B may be related to the width of the specular peak. The parameter C may be related to the falloff rate of the specular lobe. In a different example, the specular BRDF model may be a clearcoat model. The clearcoat model may refer to an additional layer in a reflectance model that simulates the effect of a thin, transparent, glossy coating applied on top of a base material using a simplified microfacet BRDF. There may be additional inputs supplied to the MLP neural network based on the parameters of the specific, target BRDF model that may be correlated with energy loss. For example, the additional input for a neural network trained for the GGX model may include the roughness parameter. In another example, the additional input for a neural network trained for the ABC specular BRDF model may include parameter B and parameter C. In a different example, the additional input for a neural network trained for the clearcoat specular BRDF model may be the Index of Refraction (IOR) parameter.

As the mathematical model of the specular compensation factor α can be computationally expensive to evaluate during rendering, the specular compensation engine 204 trains a neural network enhancement for determining the specular compensation factor α. In some implementations, the specular compensation engine 204 receives input data of viewing angles and BRDF parameters. For example, the viewing angles may include different values for incoming and outgoing directions and the BRDF parameters may include different values for roughness, parameter B, parameter C, IOR parameter, etc. The viewing angles and BRDF parameters may be varied across a range of possible inputs by the inference framework engine 168 and provided to the specular compensation engine 204. The specular compensation engine 204 may directly evaluate the mathematical model with the input data to dynamically generate the compensation factors on the fly. The specular compensation engine 204 trains the neural network using the dynamically generated compensation factors for the input data as ground truth data. For example, the specular compensation engine 204 may train the MLP neural network for specular compensation using the ground truth a values to approximate the behavior of the mathematical model. In some implementations, the specular compensation engine 204 uses reservoir sampling technique for training the neural network. The specular compensation engine 204 may apply reservoir sampling to manage the training data to facilitate a continuous learning of the neural network. As new training data of ground truth a values become available, the specular compensation engine 204 may add them to a cache (reservoir) every predetermined number of training iterations. For example, the predetermined number of training iterations may be 10,000. The trained neural network corresponding to each of the specular compensation BRDF models estimates the average energy (E_{avg}), incoming energy (E_{ω}_{ᵢ}), and outgoing energy (E_{ω}_{ₒ}) as outputs in the computation of the corresponding compensation factor α. In some implementations, the specular compensation engine 204 uses a smooth l₁ loss function but reweights the average energy (E_{avg}) to have equal contribution to the other two outputs-outgoing energy (E_{ω}_{ₒ}) and incoming energy (E_{ω}_{ᵢ}) during training.

In some implementations, the specular compensation engine 204 can improve upon the baseline implementation of the precomputed data structure corresponding to the mathematical model for specular compensation used during rendering with the deployment of the trained neural network enhancement. The specular compensation engine 204 may partially or fully replace a functionality of the pre-computed data structure used for determining specular compensation in the runtime environment with the trained neural network enhancement. For example, after the training stage, the specular compensation engine 204 replaces the previous, fixed-resolution pre-computed data structure for specular compensation with the considerably smaller network weights of the trained neural network in the low-latency runtime environment. The neural network yields a more accurate, continuous fit across at least a portion of the range of the input data and thereby improving the quality relative to the discretized and piecewise constant approximation of the pre-computed data structure. The predictions output by the neural network enhancement for specular compensation closely align with the actual values in the dataset and the neural network enhancement performs well not just at specific points but across all values within the range of the input data. After the neural network enhancement is loaded into the rendering pipeline, the neural network can be efficiently evaluated as a series of matrix multiplication operations and parallelized activation function evaluations using the CPU-based inference framework as described herein.

TABLE 1

| BRDF | GGX | ABC | Clearcoat |
|---|---|---|---|
| Baseline | 5.5% | 7.0% | 1.0% |
| Neural Network | 0.7% | 0.9% | 0.4% |

Table 1 compares the average energy loss in a white furnace test for the different BRDFs using the baseline implementation of a pre-computed data structure corresponding to the mathematical model for specular compensation and the neural network-based implementation for specular compensation described herein. With the neural network-based implementation for specular compensation, the residual error is less than 1% for all cases, significantly improving over the baseline implementation.

The atmospheric radiance evaluation engine 206 may include software and/or logic for determining the lighting contribution from the environment or light sources in a 3D scene during rendering. This step may be another compute-heavy portion of the rendering pipeline that can benefit from a neural network enhancement of the baseline implementation. A baseline implementation of a skydome model to simulate the sky and lighting effects during rendering may build one or more pre-computed data structures corresponding to the actual measurements of atmospheric data for use at runtime. The actual measurements of atmospheric data may help make the rendered image look realistic. The pre-computed data structures may be parameterized using input, such as solar elevation, observer altitude, ground albedo, viewing distance, etc, and yield both sky radiance (L_{sky}) and solar radiance (Lₛₒₗₐᵣ), as well as transmittance (τ) when queried at runtime. Sky radiance (L_{sky}) may refer to the amount of light emitted or scattered by the sky in a given direction for simulating realistic ambient outdoor lighting in the rendered scene. Solar radiance (Lₛₒₗₐᵣ) may refer to the amount of energy emitted by the sun for simulating sharp shadows, highlights, and overall brightness in the rendered scene. Transmittance (τ) may refer to the fraction of light that passes through the atmosphere after accounting for absorption and scattering for simulating atmospheric attenuation of the sky radiance and the solar radiance in the rendered scene. However, utilizing these pre-computed data structures incurs a hefty memory cost and reduced performance in the low-latency runtime environment of the rendering application 130. For example, the pre-computed data structures may be large in size and get queried at each bounce of light through the scene during rendering which can result in cache thrashing and other computational overhead in the low-latency runtime environment of the rendering application 130. Cache thrashing can lead to a number of cache misses as the recently loaded data in the cache from the pre-computed data structures may be discarded before it is accessed again. The repeated fetching of data from slower memory because of the number of cache misses can slow down the rendering. In some implementations, the precomputed data structures corresponding to each one of the sky radiance, solar radiance, and transmittance may be stored in the lighting source data 129 in the data storage 280.

The atmosphere radiance evaluation engine 206 provides a technical solution by integrating an inference of a trained machine learning model in the low-latency runtime environment of rendering. To reduce one or more of the render time and memory use footprint, the atmospheric radiance evaluation engine 206 cooperates with the machine learning engine 166 and the inference framework engine 168 to train and deploy a separate machine learning model 224 (e.g., non-linear neural network) as an enhancement for one or more of the pre-computed data structures to determine sky radiance, solar radiance, and transmittance in the low-latency runtime environment. For example, the atmospheric radiance evaluation engine 206 provides a technical improvement by replacing the two pass lookup of the pre-computed data structures in the baseline implementation (i.e., one lookup of a first pre-computed data structure for the sky radiance contribution and another lookup of a second pre-computed data structure for the solar radiance contribution) with a single multilayer perceptron (MLP) neural network (“skydome network”) that predicts both contributions (solar radiance and sky radiance) simultaneously with a single inference call and another MLP neural network that predicts the transmittance for the rendering.

The atmosphere radiance evaluation engine 206 receives the pre-computed data structures corresponding to each one of the sky radiance, solar radiance, and transmittance contributions from the lighting source data 129 of the data storage 280. The atmospheric radiance evaluation engine 206 dynamically generates sample data that may be continuous up to and across a range or domain of all or nearly all possible input values. During the training stage, the atmospheric radiance evaluation engine 206 dynamically and constantly generates new input samples to query the pre-computed data structures. This training strategy facilitates a diverse and representative set of training examples of input-output pairs. The generated samples may span the full range of possible input values for training the neural network enhancement. The generation of new examples for training may be adaptive based on conditions, such as data availability, bus latency, signal drops, etc. of the system. This adaptive data augmentation of training examples prevents the neural network from overfitting to a precomputed discrete set and, thereby enables smooth interpolation at inference. In one example, the input set of samples for generating ground truth data in training the skydome network may include wavelength, haziness, zenith angle, solar angle, shadow angle, solar elevation, ground color (RGB), albedo, etc. In another example, the input set of samples for generating ground truth data in training the transmittance network may include wavelength, haziness, zenith angle, distance, etc. The atmospheric radiance evaluation engine 206 queries the pre-computed data structures corresponding to each one of sky radiance, solar radiance, and transmittance using the input sample data to return output values of sky radiance, solar radiance, and transmittance. In some implementations, the atmospheric radiance evaluation engine 206 may directly query the pre-computed data structures loaded in the renderer with the input sample data for the output values.

The atmospheric radiance evaluation engine 206 trains a first neural network (skydome network) using the sky radiance and the solar radiance corresponding to the input sample data as ground truth data. In some implementations, the atmospheric radiance evaluation engine 206 periodically regenerates the entire training dataset for the skydome network every predetermined number of training iterations. For example, the atmospheric radiance evaluation engine 206 resets the training data completely for the skydome network every 50,000 iterations and starts anew with different or updated sample data. In one example training of the skydome network, the atmospheric radiance evaluation engine 206 may be configured to sample the solar elevation and distance according to the bin edges from external data sources, set the ground color and haziness to zero independently half the time to ensure adequate sampling, perform grid sampling using a 1024×256 resolution grid corresponding to angular azimuth and elevation to ensure comprehensive hemisphere sampling, and include samples for every batch that were from a few degrees along the horizon at a 50:50 ratio to preserve the faint line along the horizon (this effectively doubles the batch size of the skydome network). In addition, the atmospheric radiance evaluation engine 206 uses a vanilla l₁ loss function but weights the sky radiance contribution more heavily by a factor of 10 during training. The atmospheric radiance evaluation engine 206 can improve upon the baseline implementation of the pre-computed data structure corresponding to each one of the sky radiance and the solar radiance used during the rendering with the deployment of the first neural network. The atmospheric radiance evaluation engine 206 may partially or fully replace a functionality of one or more pre-computed data structures for determining sky radiance and solar radiance contributions in the runtime environment with the deployed first neural network.

The atmospheric radiance evaluation engine 206 trains a second neural network (e.g., transmittance network) using the transmittance corresponding to the input sample data as ground truth data. In some implementations, the atmospheric radiance evaluation engine 206 periodically regenerates the entire training dataset for the transmittance network every predetermined number of iterations. For example, the atmospheric radiance evaluation engine 206 may reset the training data completely for the transmittance network every 100,000 iterations and starts anew with different or updated sample data. In another example training, the atmospheric radiance evaluation engine 206 may use a custom weighted l₁ loss function that more heavily weights elements closer to the horizon (i.e., with a weight of 10). The atmospheric radiance evaluation engine 206 can improve upon the baseline implementation of the pre-computed data structure corresponding to the transmittance used during the rendering with the deployment of the second neural network. The atmospheric radiance evaluation engine 206 may partially or fully replace a functionality of the pre-computed data structures for determining transmittance contributions in the runtime environment with the deployed second neural network.

After the training stage, in some implementations, the atmospheric radiance evaluation engine replaces the previous, fixed-resolution pre-computed data structures for estimating solar radiance, sky radiance, and transmittance with the trained neural networks. During inference, the neural networks can be less costly to evaluate compared to the pre-computed data structures in the low-latency runtime environment. The weights of the neural networks may be significantly smaller in size compared to the pre-computed data structures and the neural networks can provide a continuous fit mitigating interpolation inaccuracies from the fixed-resolution model of the pre-computed data structures. After the neural network enhancements are loaded into the renderer, the networks can be efficiently evaluated or inferred as a series of matrix multiplication operations and parallelized activation function evaluations using the CPU-based inference framework as described herein. In some implementations, the atmospheric radiance evaluation engine 206 may compress a larger atmospheric model to use in spectral rendering. For example, the atmospheric radiance evaluation engine 206 may integrate a pre-computed data structure including wide spectral ranges at multiple observer altitudes from an external source into the training and deployment of a neural network enhancement with minimal modifications.

In some implementations, the specular compensation engine 204 and the atmospheric radiance evaluation engine 206 may use the machine learning library 127 and the GPU cluster 131 in the cloud computing resource 120 for training their corresponding neural networks.

TABLE 2

| Model | Inputs | Outputs |
|---|---|---|
| GGX | outgoing direction (ω₀), | outgoing energy (E_{ω}_{₀}), |
| | incident direction (ωᵢ), | incoming energy (E_{ω}_{ᵢ}), |
| | roughness | average energy (E_{avg}) |
| ABC | outgoing direction (ω₀), | outgoing energy (E_{ω}_{₀}), |
| | incident direction (ωᵢ), | incoming energy (E_{ω}_{ᵢ}), |
| | B, C | average energy (E_{avg}) |
| Clearcoat | outgoing direction (ω₀), | outgoing energy (E_{ω}_{₀}), |
| | incident direction (ωᵢ), | incoming energy (E_{ω}_{ᵢ}), |
| | roughness, IOR | average energy (E_{avg}) |
| Skydome | wavelength, haziness, | sky radiance (L_{sky}), |
| | zenith angle (θ), solar angle (γ), | solar radiance (Lₛₒₗₐᵣ) |
| | shadow angle (σ), solar elevation, | |
| | ground color (RGB), albedo | |
| Transmittance | wavelength, haziness, | transmittance (τ) |
| | zenith angle (θ), distance | |

Table 2 includes example inputs and outputs for the specular compensation networks (e.g., GGX, ABC, Clearcoat) and atmospheric radiance evaluation networks (Skydome, Transmittance).

TABLE 3

| Model | GGX | ABC | Clearcoat | Skydome | Trans. |
|---|---|---|---|---|---|
| Inputs | 3 | 4 | 4 | 10 | 4 |
| Outputs | 3 | 3 | 3 | 2 | 1 |
| Hidden layers | 1 | 3 | 3 | 3 | 3 |
| Nodes per layer | 40 | 10 | 10 | 40 | 20 |
| Activation Function | Sigmoid | Sigmoid | Sigmoid | ReLU | ReLU |
| Act. in final layer | No | Yes | Yes | No | No |
| Normalization | [−1, 1] | [−1, 1] | [−1, 1] | [0, 1] | [−1, 1] |
| Batch size | 128 | 128 | 128 | 8,192 | 64 |
| Optimization | Adam | Adam | Adam | AdamW | Adam |
| Learning rate | 1.0e−3 | 1.0e−3 | 5.0e−3 | 1.0e−4 | 1.0e−4 |
| Total parameters | 283 | 193 | 193 | 2,162 | 541 |
| FLOPS | 683 | 455 | 455 | 4,398 | 1,081 |
| LUT size (# of floats) | 1,056 | 4,352 | 4,352 | 51,464,160 | 7,500,849 |
| Compression factor | 3.7× | 22.5× | 22.5× | 23,804× | 13,865× |

Table 3 includes examples of the deployed neural network architectures including the total number of parameters and improvements in terms of compression relative to the baseline implementation corresponding to pre-computed data structures. The neural network enhancement in the low-latency runtime environment achieves significant compression relative to the baseline implementation.

Referring back to the low-latency rendering application 130, in some implementations, the path tracer engine 202 implements the CPU-based inference of the neural network enhancements during the rendering stage of the pipeline in cooperation with the inference framework engine 168. In some implementations, the path tracer engine 202 uses a rendering system implemented in C++. The path tracer engine 202 imports the network weights of a combination of one or more neural networks from the specular compensation engine 204 (corresponding to specular compensation neural network) and the atmospheric radiance evaluation engine 206 (corresponding to skydome network and transmittance network) into the low-latency runtime environment of the renderer as one or more static matrices. The static weight matrices of the neural network enhancements may be significantly smaller in size compared to the one or more pre-computed data structures in the baseline implementation. This provides a technical improvement by significantly freeing up memory in the runtime environment of the rendering application 130 that may be used more effectively for further speeding up the computational performance of rendering. For example, the rendering application 130 may benefit from freeing up memory space for producing more realistic geometry or creating more realistic textures in the rendered scene. The latency of inferring the neural network enhancement in the runtime environment may be considerably lower than evaluating a quantitative model associated with the baseline implementation of the pipeline element or accessing a fixed-resolution, pre-computed data structure approximating the quantitative model. This provides another technical improvement where a plurality of inference calls to the neural network enhancement can be asynchronous in the runtime environment and the neural network enhancement may independently and efficiently generate output for the plurality of inference calls. In one example, each inference call may correspond to a batch size including one or more samples of unique input data and sent into the rendering stage of the pipeline from across a plurality of pixels in the 3D scene.

The path tracer engine 202 samples a light through a 3D scene during rendering. The path tracer engine 202 simulates a path of light as it bounces through the 3D scene. Each bounce of light in the 3D scene contributes to the realistic lighting and reflections in the rendered scene and may correspond to a thread asynchronously invoking a combination of the trained neural networks in the low-latency runtime environment of the rendering application 130. The path tracer engine 202 normalizes the input data of the sampled light before sending the input data to the neural network for inference. For example, the path tracer engine 202 normalizes the input for the one or more specular compensation networks and the transmittance network in the range of [−1, 1]. In another example, the path tracer engine 202 normalizes the input for the skydome network in the range of [0, 1].

The path tracer engine 202 can feed the normalized data to a combination of a first neural network for specular compensation, a second neural network for skydome, and a third neural network for transmittance in each thread. As described herein, the path tracer engine 202 may utilize parallel computing power offered by the CPU cluster 122 in the cloud computing resource 120 for rendering with multiple threads working simultaneously and asynchronously. The path tracer engine 202 asynchronously determines irradiance contribution across a pixel in each thread by evaluating each neural network as a series of matrix multiplication operations and parallelized activation functions across their layers using one or more CPU-based libraries. For example, the path tracer engine 202 may use a first CPU-based library for matrix multiplications. The first CPU-based library may be a C++ template library for linear algebra that provides efficient matrix and vector operations. In another example, the path tracer engine 202 may use a second CPU-based library for applying activation functions. The second CPU-based library may be a compiler that includes standard libraries for math, bit manipulation, memory, and cross-lane operations. Both libraries may make use of vectorization that can completely forgo any operation on the GPU. The technical solution of using the one or more CPU-based libraries by the path tracer engine 202 may enable a vectorization of the series of matrix multiplication operations and the activation functions applied in parallel across the layers of the one or more deployed neural networks in the runtime environment. For example, the one or more efficient CPU-based libraries can vectorize the learned mathematical calculations of the deployed neural network at the time of inference creating ‘vectorized’ code from scalar code and thereby enabling operations to be performed on entire arrays or vectors at once, instead of individual elements within those arrays. This vectorization provides a technical improvement in that it significantly reduces the number of instructions executable by one or more CPUs, reduces memory reads and cache misses in the runtime environment. In other words, the technical improvement may correspond to reducing the latency associated with inferring a combination of one or more neural network enhancements in the rendering pipeline.

In some implementations, the path tracer engine 202 may apply a range compressor on the output radiance of the second neural network for skydome to obtain a full dynamic range. The path tracer engine 202 may apply a range compressor on the output radiance of skydome network to better handle the dynamic range for the skydome network. For example, the path tracer engine 202 inverts the range compressor for the skydome network to obtain the full dynamic range. The range compressor may be optimized in the space:

$${T}_{x} = \frac{log ( 1 + μ x )}{log ( 1 + μ )}$$

In some implementations, the path tracer engine 202 may use the CPU-based inference framework for an anisotropic version of the specular compensation network which may include two roughness parameters. A pre-computed data structure corresponding to the baseline implementation may require an additional dimension (i.e., a 3D table) and a coarser resolution for the pre-computed data structure. In contrast, the neural network enhancement of the pre-computed data structure in the low-latency runtime environment may need adding one additional parameter to the input sample set and retraining of the neural network to generate high quality results.

It is to be understood that the technical solution described in the present disclosure may not be limited to specular compensation and atmospheric radiance estimation in the shading stage of the rendering pipeline discussed by way of example. The application of the CPU-based inference framework described herein may equally be beneficial for other stages of the rendering pipeline, at least as discussed herein.

It is to be further understood that the technical solution described in the present disclosure may be applied to reduce the latency of GPU-dominant applications as well. Even though the GPU-dominant applications may execute most of their processes on the GPU, they may frequently switch the context to the CPU. The techniques described in the present disclosure may be applied to optimize the inference of a machine learning model on the GPU to decrease the context-switching of the GPU-dominant applications to the CPU.

As shown in FIG. 2, the computing system 200 includes a machine learning engine 166 to train one or more machine learning models 224. In some implementations, the machine learning engine 166 receives the training data 215 from one or more of the inference framework engine 168, specular compensation engine 204, and the atmospheric radiance evaluation engine 206 for training the machine learning model 224. In some implementations, the machine learning model 224 may be a neural network model and includes a layer and/or layers of memory units where memory units each have corresponding weights. A variety of neural network models can be utilized including feed forward neural networks, convolutional neural networks, recurrent neural networks, radial basis functions, other neural network models, as well as combinations of several neural networks. Additionally, or alternatively, the machine learning model 224 can represent a variety of machine learning techniques in addition to neural networks, for example, support vector machines, decision trees, Bayesian networks, random decision forests, k-nearest neighbors, linear regression, least squares, other machine learning techniques, and/or combinations of machine learning techniques. In some implementations, neural network models may be trained to perform a single task. In other implementations, neural network models may be trained to perform multiple tasks.

The machine learning engine 166 may generate training instances from the training dataset 215 to train the machine learning model 224. The machine learning engine 166 may apply a training instance as input to machine learning model 224. In some implementations, the machine learning model 224 may be trained using any one of at least one of supervised learning (e.g., support vector machines, neural networks, logistic regression, linear regression, stacking, gradient boosting, etc.), unsupervised learning (e.g., clustering, neural networks, singular value decomposition, principal component analysis, etc.), or semi-supervised learning (e.g., generative models, transductive support vector machines, etc.). Additionally, or alternatively, machine learning models in accordance with some implementations may be deep learning networks including recurrent neural networks, convolutional neural networks (CNN), networks that are a combination of multiple networks, etc. For example, the machine learning engine 166 may generate a predicted machine learning model output by applying training input to the machine learning model 224. Additionally, or alternatively, the machine learning engine 166 may compare the predicted machine learning model output with a machine learning model known output from the training instance and, using the comparison, update one or more weights in the machine learning model 224. In some implementations, one or more weights may be updated by backpropagating the difference over the entire machine learning model 224.

The machine learning engine 166 may test a trained machine learning model according to some implementations. The machine learning engine 166 may apply a testing instance as input to the trained machine learning model 224. A predicted output generated by applying a testing instance to the trained machine learning model 224 may be compared with a known output for the testing instance to update an accuracy value (e.g., an accuracy percentage) for the machine learning model 224.

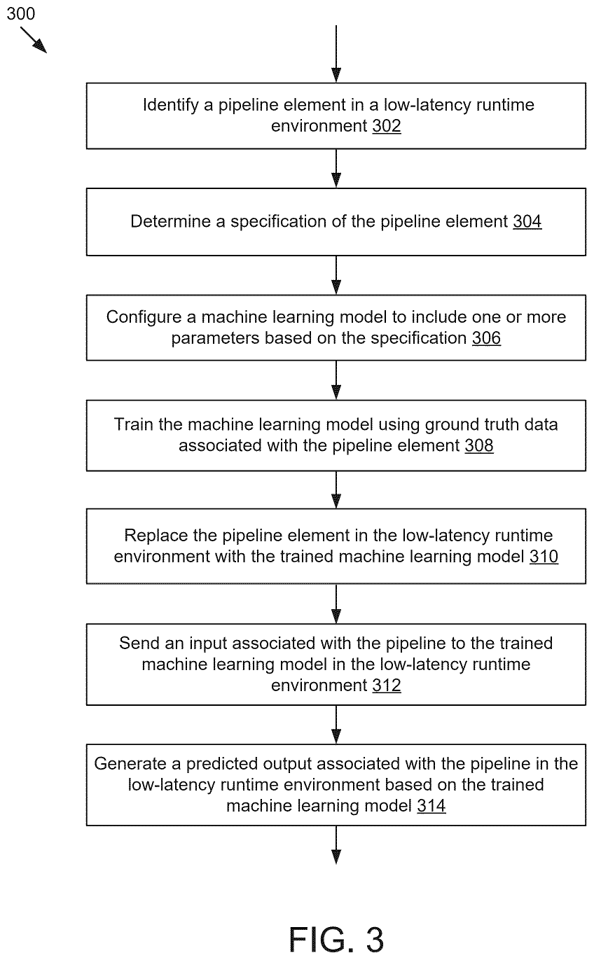

Referring now to FIG. 3, a method 300 for training and deploying a machine learning model enhancement in a low-latency runtime environment in accordance with some implementations is illustrated. The method 300 may be a sequence of operations or process steps performed by a system of one or more computers in one or more locations, including, for example, the inference framework engine 168 in the computing system 200 of FIG. 2, by another computer system that is separate from the inference framework engine 168 in FIG. 2, or any combination thereof. Moreover, while in some implementations, the sequence of operations illustrated in any one of FIG. 3 may be fully automated, in other implementations some steps may be performed and/or guided through human intervention. Furthermore, it will be appreciated that the order of operations in the sequence may be varied, and that some operations may be performed in parallel and/or iteratively in some implementations.

At 302, the inference framework engine 168 identifies a pipeline element in a low-latency runtime environment. For example, the pipeline element may refer to a single processing stage of a pipeline corresponding to a high-performance computing application. The pipeline element may correspond to one or more low-latency operations executable by one or more CPUs in the runtime environment.

At 304, the inference framework engine 168 determines a specification of the pipeline element. For example, the inference framework engine 168 determines a number of inputs and outputs, a memory size, and a measure of computational performance of the pipeline element.

At 306, the inference framework engine 168 configures a machine learning model to include one or more parameters based on the specification. For example, the inference framework engine 168 configures a number of parameters of a multilayer perceptron (MLP) neural network in terms of its size, such as a number of layers, a number of nodes, layer width, etc. based on the specification of the pipeline element.

At 308, the inference framework engine 168 trains the machine learning model using ground truth data associated with the pipeline element. In some implementations, the inference framework engine 168 may train the machine learning model to be an approximation of the mathematical model associated with the pipeline element. For example, the trained machine learning model may provide fast, approximate output for any input, mimicking the behavior of the mathematical model. In some implementations, the inference framework engine 168 may train the machine learning model to be an approximation of the pre-computed data structure used by the pipeline element. For example, the trained machine learning model may provide a continuous fit by mitigating the interpolation inaccuracies of the pre-computed data structure by generating output approximations for values between the samples of the pre-computed data structure, thereby balancing accuracy and performance.

At 310, the inference framework engine 168 replaces the pipeline element in the low-latency runtime environment with the trained machine learning model. For example, the inference framework engine 168 may deploy the machine learning model as one or more static weight matrices in a C++ runtime environment.

At 312, the inference framework engine 168 sends an input associated with the pipeline to the trained machine learning model in the low-latency runtime environment. The inference framework engine 168 deploys the trained machine learning model for inference using the one or more imported static matrices and one or more CPU-based libraries.

At 314, the inference framework engine 168 generates a predicted output associated with the pipeline in the low-latency runtime environment based on the trained machine learning model. The inference framework engine 168 returns the predicted output of the trained neural network to an input of another pipeline element in the low-latency runtime environment of the application.

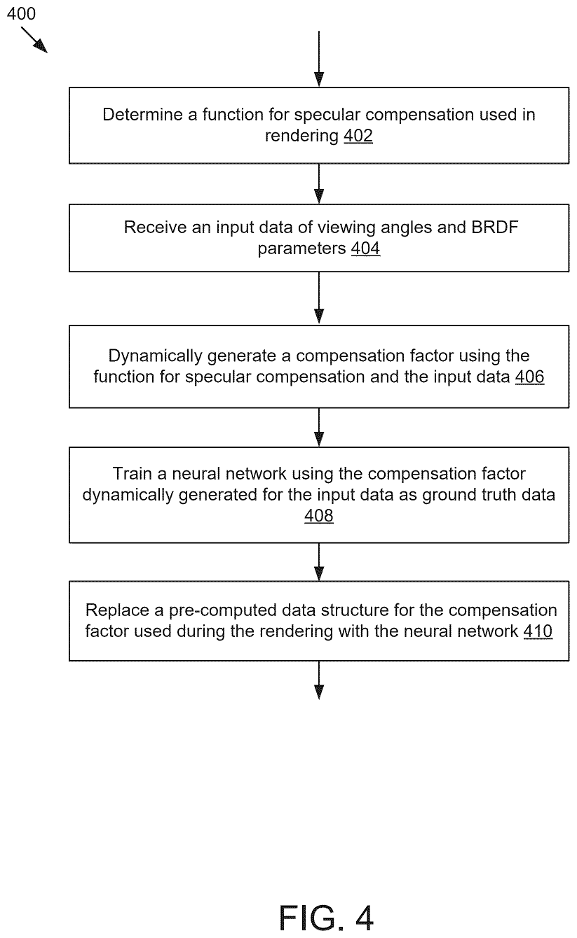

Referring now to FIG. 4, a method 400 for training a neural network for determining specular compensation in accordance with some implementations is illustrated. The method 400 may be a sequence of operations or process steps performed by a system of one or more computers in one or more locations, including, for example, the specular compensation engine 204 in the computing system 200 of FIG. 2, by another computer system that is separate from the specular compensation engine 204 in FIG. 2, or any combination thereof. Moreover, while in some implementations, the sequence of operations illustrated in any one of FIG. 4 may be fully automated, in other implementations some steps may be performed and/or guided through human intervention. Furthermore, it will be appreciated that the order of operations in the sequence may be varied, and that some operations may be performed in parallel and/or iteratively in some implementations.

At 402, the specular compensation engine 204 determines a function for specular compensation used in rendering. The specular compensation engine 204 determines the mathematical model of the specular compensation factor α described above. The mathematical model for the specular compensation can be computationally expensive to evaluate during render runtime.

At 404, the specular compensation engine 204 receives an input data of viewing angles and BRDF parameters. For example, the viewing angles may include different values for incoming and outgoing directions and the BRDF parameters may include different values for roughness, parameter B, parameter C, IOR parameter, etc.

At 406, the specular compensation engine 204 dynamically generates a compensation factor using the function for specular compensation and the input data. The specular compensation engine 204 may directly call the function for specular compensation in the renderer with the input data to dynamically generate the compensation factor on the fly.

At 408, the specular compensation engine 204 trains a neural network using the compensation factor dynamically generated for the input data as ground truth data. The specular compensation engine 204 trains the MLP neural network for specular compensation using the ground truth a values for each sample of the input data.

At 410, the specular compensation engine 204 replaces a pre-computed data structure for the compensation factor used during the rendering with the neural network. After the training stage, the specular compensation engine 204 replaces the previous, fixed-resolution pre-computed data structure for specular compensation with the considerably smaller network weights.

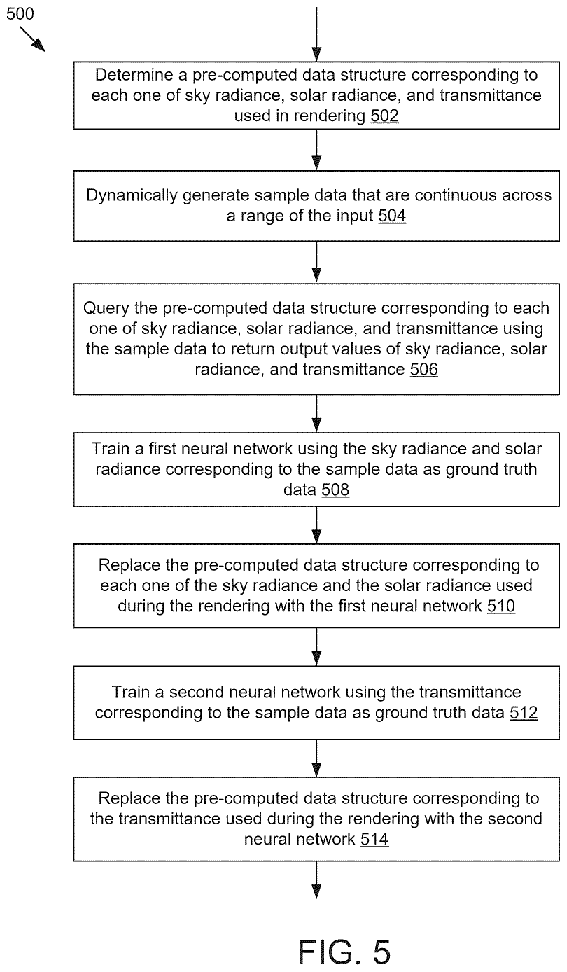

Referring now to FIG. 5, a method 500 for training a neural network for determining radiance and transmittance information in accordance with some implementations is illustrated. The method 500 may be a sequence of operations or process steps performed by a system of one or more computers in one or more locations, including, for example, the atmospheric radiance evaluation engine 206 in the computing system 200 of FIG. 2, by another computer system that is separate from the atmospheric radiance evaluation engine 206 in FIG. 2, or any combination thereof. Moreover, while in some implementations, the sequence of operations illustrated in any one of FIG. 5 may be fully automated, in other implementations some steps may be performed and/or guided through human intervention. Furthermore, it will be appreciated that the order of operations in the sequence may be varied, and that some operations may be performed in parallel and/or iteratively in some implementations.

At 502, the atmospheric radiance evaluation engine 206 determines a pre-computed data structure corresponding to each one of sky radiance, solar radiance, and transmittance used in rendering.

At 504, the atmospheric radiance evaluation engine 206 dynamically generates sample data that are continuous across a range of the input. In one example, the input samples for generating ground truth data in training the skydome network may include wavelength, haziness, zenith angle, solar angle, shadow angle, solar elevation, ground color (RGB), albedo, etc. In another example, the input samples for generating ground truth data in training the transmittance network may include wavelength, haziness, zenith angle, distance, etc.

At 506, the atmospheric radiance evaluation engine 206 queries the pre-computed data structure corresponding to each one of sky radiance, solar radiance, and transmittance using the sample data to return output values of sky radiance, solar radiance, and transmittance.

At 508, the atmospheric radiance evaluation engine 206 trains a first neural network (skydome network) using the sky radiance and the solar radiance corresponding to the sample data as ground truth data.

At 510, the atmospheric radiance evaluation engine 206 replaces the pre-computed data structure corresponding to each one of the sky radiance and the solar radiance used during the rendering with the first neural network.

At 512, the atmospheric radiance evaluation engine 206 trains a second neural network (transmittance network) using the transmittance corresponding to the sample data as ground truth data.

At 514, the atmospheric radiance evaluation engine 206 replaces the pre-computed data structure corresponding to the transmittance used during the rendering with the second neural network.

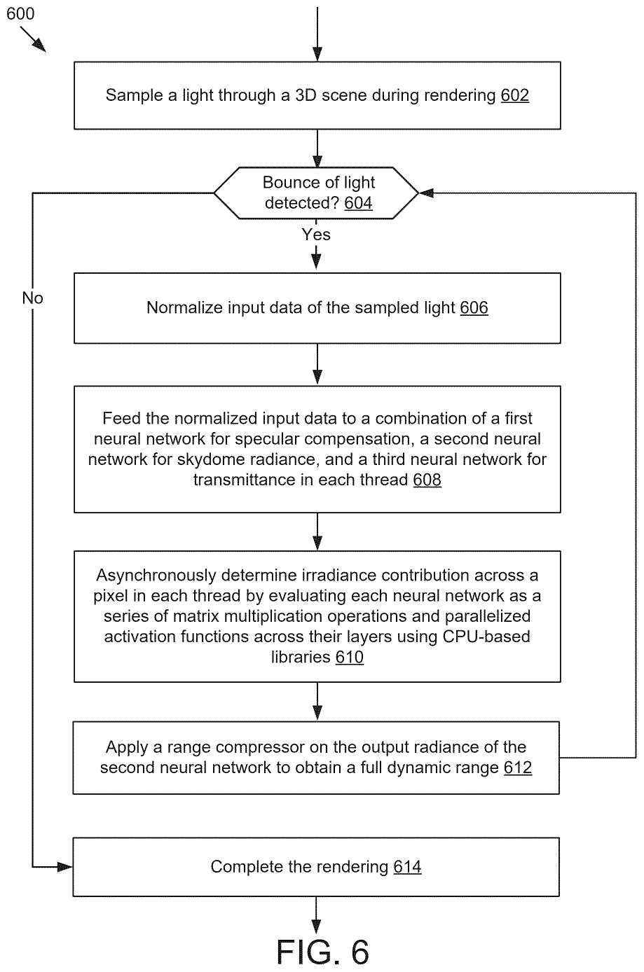

Referring now to FIG. 6, a method 600 for utilizing one or more neural networks for intra-rendering processes in accordance with some implementations is illustrated. The method 600 may be a sequence of operations or process steps performed by a system of one or more computers in one or more locations, including, for example, the path tracer engine 202 in the computing system 200 of FIG. 2, by another computer system that is separate from the path tracer engine 202 in FIG. 2, or any combination thereof. Moreover, while in some implementations, the sequence of operations illustrated in any one of FIG. 6 may be fully automated, in other implementations some steps may be performed and/or guided through human intervention. Furthermore, it will be appreciated that the order of operations in the sequence may be varied, and that some operations may be performed in parallel and/or iteratively in some implementations.

At 602, the path tracer engine 202 samples a light through a 3D scene during rendering. The path tracer engine 202 simulates a path of light as it bounces through the 3D scene.

At 604, the path tracer engine 202 detects whether light bounced through the 3D scene. Each bounce of light in the 3D scene contributes to the realistic lighting and reflections in the rendered scene and may correspond to a thread asynchronously invoking the trained neural networks in the low-latency runtime environment of the rendering application.

If there is a detection of light bounce, at 606, the path tracer engine 202 normalizes input data of the sampled light.

At 608, the path tracer engine 202 feeds the normalized input data to a combination of a first neural network for specular compensation, a second neural network for skydome radiance, and a third neural network for transmittance in each thread.

At 610, the path tracer engine 202 asynchronously determines irradiance contribution across a pixel in each thread by evaluating each neural network as a series of matrix multiplication operations and parallelized activation functions across their layers using CPU-based libraries.

At 612, the path tracer engine 202 applies a range compressor on the output radiance of the second neural network to obtain a full dynamic range.

If there is no detection of light bounce, at 614, the path tracer engine 202 completes the rendering.

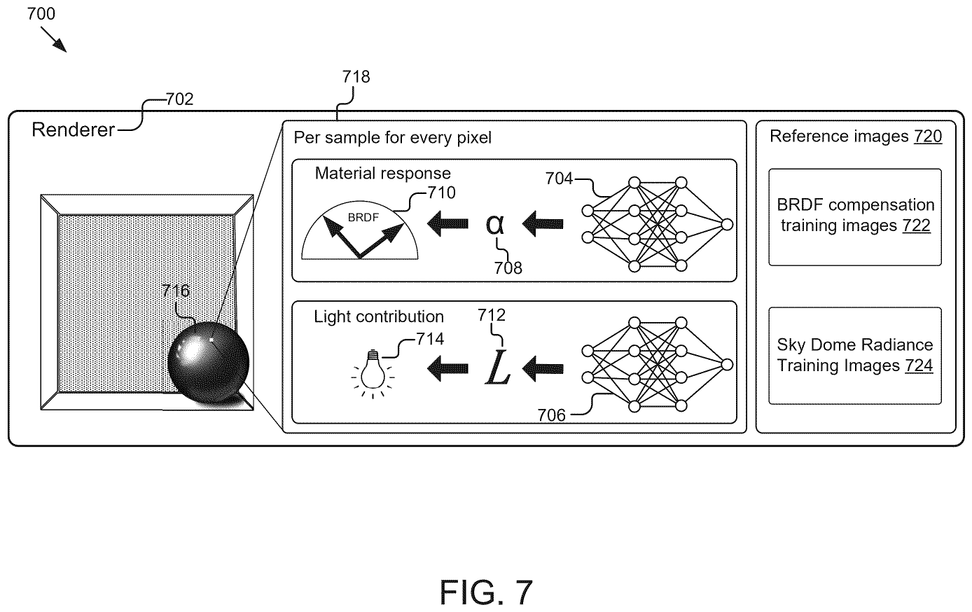

FIG. 7 illustrates a graphical representation 700 of an example renderer in a low-latency runtime environment in accordance with some implementations. In FIG. 7, the renderer 702 integrates a first neural network 704 (e.g., BRDF compensation) to predict the specular BRDF compensation factor α 708 for the computation of the material response 710 and a second neural network 706 (e.g., sky dome radiance) to predict the radiance L 712 for the computation of the atmospheric light contribution 714 at every bounce of light (e.g., per sample for every pixel 718) in the 3D scene 716. In FIG. 7, the graphical representation 700 depicts the reference images 720 used in training the neural networks beforehand in a separate offline process. For example, the first neural network 704 is trained on a plurality of BRDF compensation training images 722 and the second neural network 706 is trained on a plurality of sky dome radiance training images 724.

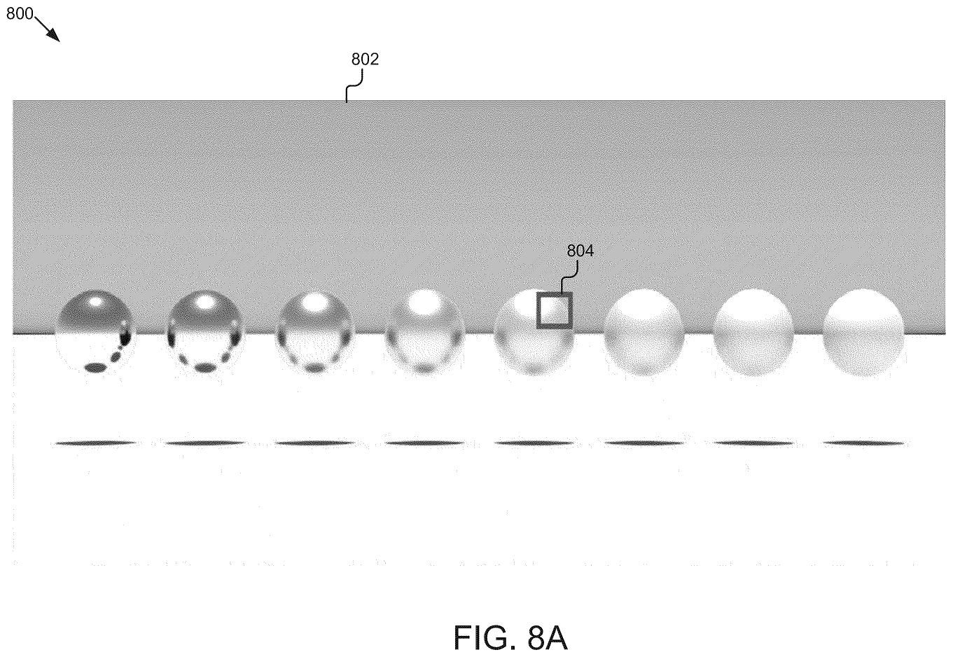

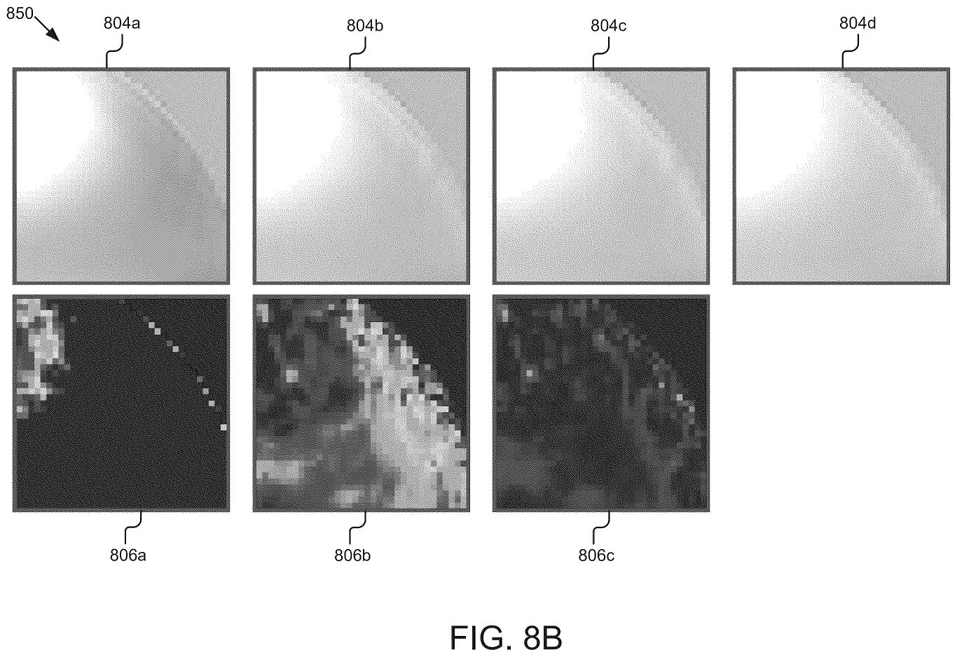

FIGS. 8A-8B illustrate graphical representations 800-850 depicting an example of a scene rendering and a performance comparison of a renderer in accordance with some implementations.

In FIG. 8A, for example, the graphical representation 800 depicts a scene 802 rendered by the renderer using a first BRDF model, such as the GGX (“Ground Glass with unknown distribution”) model. The GGX model, also known as Trowbridge-Reitz distribution model, may be used in the renderer to control the appearance of a shiny or metallic surface in a scene by adjusting parameters such as roughness, etc. The renderer uses a neural network trained for computing the specular compensation to apply to the first BRDF model for rendering the scene 802. For example, the scene 802 depicts metallic spheres rendered with increasing roughness using the GGX model layers at a sampling rate of 256 samples per pixel (SPP). In FIG. 8A, the close-up 804 in the scene 802 is highlighted for performance comparison in FIG. 8B.

In FIG. 8B, the graphical representation 850 depicts a performance comparison of the renderer integrating the neural network for specular compensation against baseline implementation using the close-up 804 of the rendered scene 802 as an example. In FIG. 8B, the graphical representation 850 depicts a close-up 804 of each scene rendered using a different approach and a corresponding hot spot analysis 806 of the error determined in the close-up 804. In one example, mean relative squared error (MrSE) may be used to evaluate the accuracy of the BRDF model by comparing the predicted reflectance values (from the first BRDF model) to the ground truth data of a reference scene. The hot spot analysis based on MrSE calculations identifies the areas with high values of error (hot spots) shown in red and low values of error (cold spots) shown in blue in the close-up 804.

In FIG. 8B, the graphical representation 850 depicts a first close-up 804a of a scene rendered with no specular compensation applied to the first BRDF model and the corresponding hot spot analysis 806a of the error in the first close-up 804a. The graphical representation 850 further depicts a second close-up 804b of a scene rendered using a pre-computed data structure associated with the baseline implementation for applying specular compensation to the first BRDF model and the corresponding hot spot analysis 806b of the error in the second close-up 804b. For example, the baseline implementation may use a resolution of 32×32 and 16×16×16 for 2D and 3D table data structures, respectively. The graphical representation 850 further depicts a third close-up 804c of a scene rendered using the non-linear neural network enhancement implementation for applying specular compensation to the first BRDF model and the corresponding hot spot analysis 806c of the error in the third close-up 804c. The graphical representation 850 further depicts a fourth close-up 804d of a reference scene against which the previous close-ups 804a, 804b, and 804c are compared. For example, the reference scene may be rendered at a sampling rate of 4096 samples per pixel (SPP) using a high resolution pre-computed data structure (e.g., 1024×1024 for 2D and 64×64×64 for 3D table data structures), which can be highly intractable in practice and significantly increases memory overhead and render times.

The render times of the renderer for rendering each scene depicted in the first close-up 804a, the second close-up 804b, and the third close-up 804c may be similar. However, the comparison of the corresponding hot spot analyses 806a, 806b, and 806c shows that the output of the renderer integrating the neural network enhancement implementation for applying specular compensation to the first BRDF model provides the highest quality. For example, the MrSE values corresponding to each of the hot spot analyses 806a, 806b, and 806c is 0.00477, 0.00021, and 0.00013 respectively, which indicates that the output of the neural network enhancement implementation (e.g., third close-up 804c) can be closer to the true values of the reference scene in the fourth close-up 804d, reflecting better overall performance due to its lowest MrSE value. Additionally, there can be significant improvement in terms of compact storage of neural network weights over the pre-computed data structure associated with the baseline implementation, with little to no change in render times. The visualization of the hot spot analysis 806c for the third close-up 804c shows that the neural network enhancement implementation provides at least a technical improvement to minimize or eliminate errors with respect to the reference scene. For example, the hot spot analysis 806c, when compared to each of the other hot spot analyses 806a and 806b, predominantly shows cold spots of low errors.

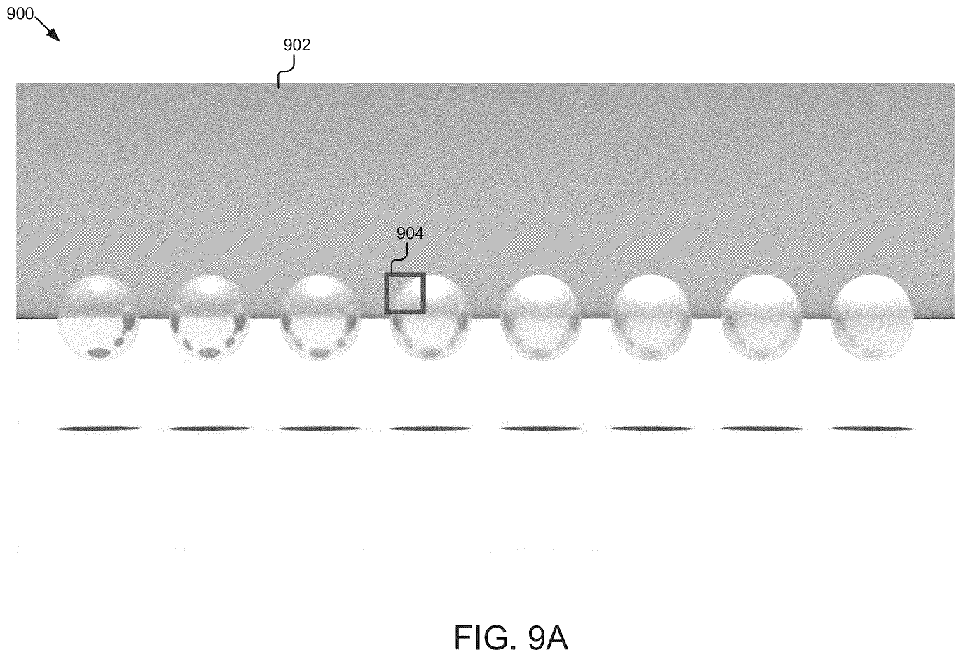

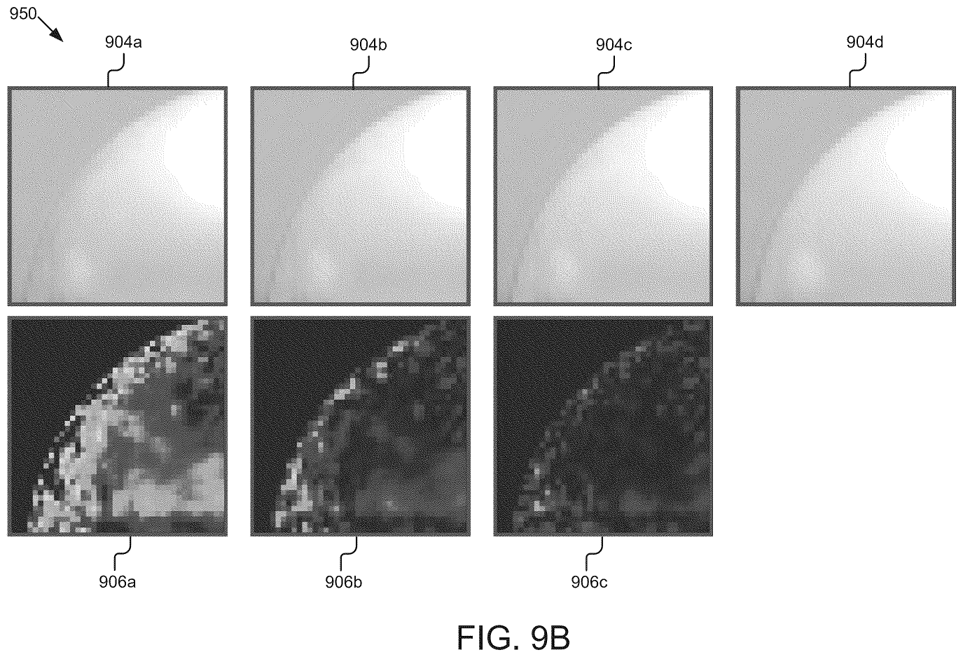

FIGS. 9A-9B illustrate graphical representations 900-950 depicting another example of a scene rendering and a performance comparison of a renderer in accordance with some implementations. In FIG. 9A, for example, the graphical representation 900 depicts a scene 902 rendered by the renderer using a second BRDF model, such as clearcoat model. The clearcoat model may be implemented as a separate BRDF lobe layered on top of the BRDF of a base material. This means that, in addition to the reflection properties (e.g., diffuse and metallic reflections) of the base material, there can be an extra specular reflection calculated for the clearcoat layer by the clearcoat model. As similarly described with reference to FIGS. 8A-8B, the renderer uses a different neural network trained for computing the specular compensation to apply to the second BRDF model for rendering the scene 902. For example, the scene 902 depicts metallic spheres rendered with increasing roughness using the clearcoat model layers at a sampling rate of 256 samples per pixel (SPP). In FIG. 9A, the close-up 904 in the scene 902 is highlighted for another performance comparison in FIG. 9B.

In FIG. 9B, the graphical representation 950 depicts a performance comparison of the renderer integrating the neural network for specular compensation against baseline implementation using the close-up 904 of the rendered scene 902 as an example. As similarly described with reference to FIG. 8B, the graphical representation 950 in FIG. 9B depicts a first close-up 904a of a scene rendered with no specular compensation applied to the second BRDF model and the corresponding hot spot analysis 906a of the error in the first close-up 904a. The graphical representation 950 further depicts a second close-up 904b of a scene rendered using a pre-computed data structure associated with the baseline implementation for applying specular compensation to the second BRDF model and the corresponding hot spot analysis 906b of the error in the second close-up 904b. The graphical representation 950 further depicts a third close-up 904c of a scene rendered using the non-linear neural network enhancement implementation for applying specular compensation to the second BRDF model and the corresponding hot spot analysis 906c of the error in the third close-up 904c. The graphical representation 950 further depicts a fourth close-up 904d of a reference scene against which the previous close-ups 904a, 904b, and 904c are compared.

As similarly described with reference to FIGS. 8A-8B, the render times of the renderer for rendering each scene depicted in the first close-up 904a, the second close-up 904b, and the third close-up 904c may be similar. However, the comparison of the corresponding hot spot analyses 906a, 906b, and 906c shows that the output of the renderer integrating the neural network enhancement implementation for applying specular compensation to the second BRDF model provides the highest quality along with compact storage of neural network weights over the pre-computed data structure baseline implementation, with little to no change in render times. For example, the MrSE values corresponding to each of the hot spot analyses 906a, 906b, and 906c is 0.00108, 0.00014, and 0.00013 respectively, which indicates that the output of the neural network enhancement implementation (e.g., third close-up 904c) can be closer to the true values of the reference scene in the fourth close-up 904d, reflecting better overall performance due to its lowest MrSE value. The visualization of the hot spot analysis 906c for the third close-up 904c shows that the neural network enhancement implementation provides at least a technical improvement to minimize or eliminate errors with respect to the reference scene. For example, the hot spot analysis 906c, when compared to each of the hot spot analyses 906a and 906b, predominantly shows cold spots of low errors.

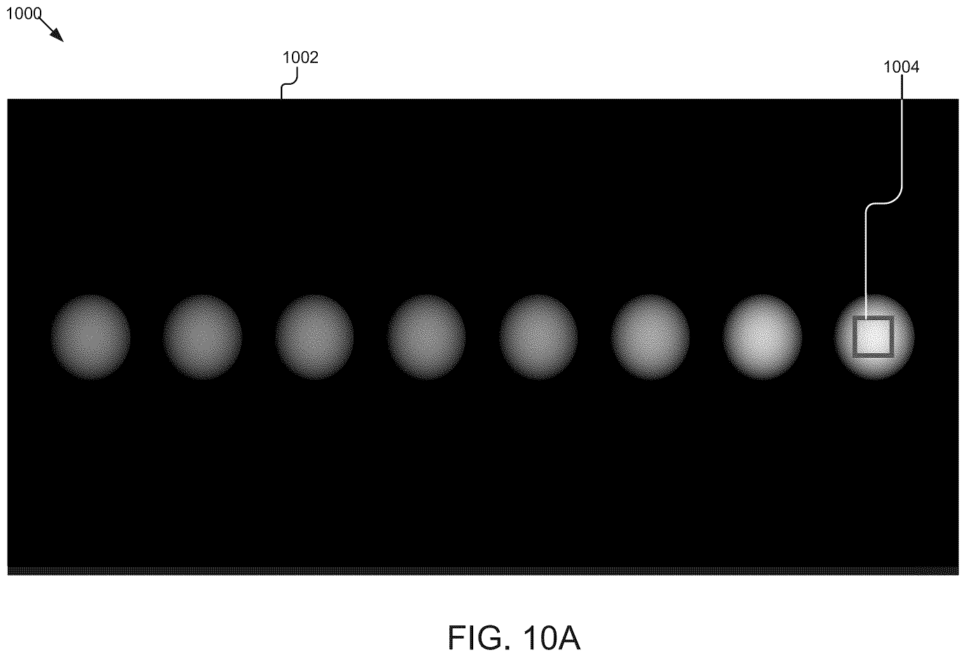

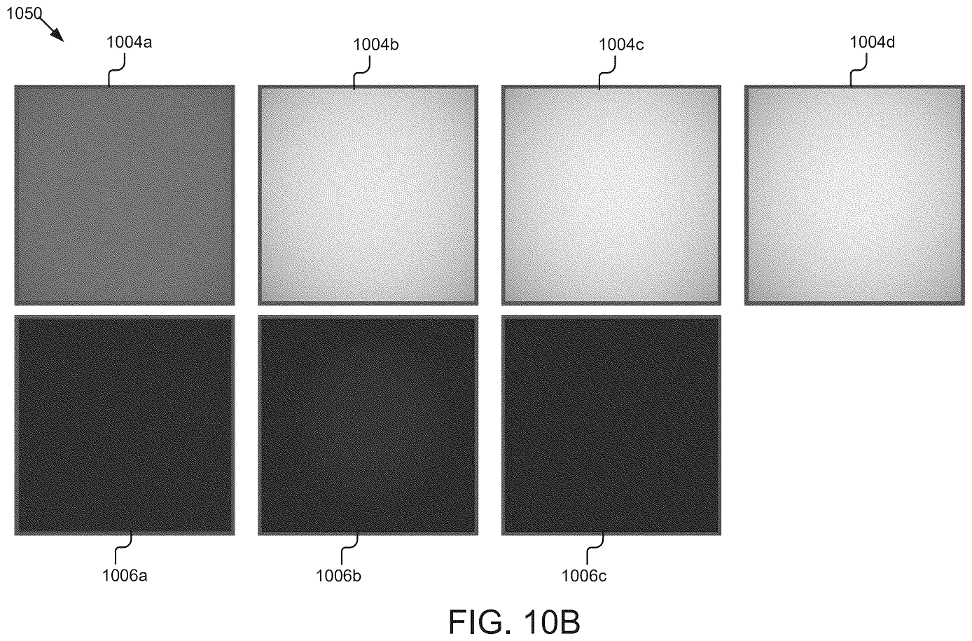

FIGS. 10A-10B illustrate graphical representations 1000-1050 depicting another example of a scene rendering and a performance comparison of a renderer in accordance with some implementations. In FIG. 10A, for example, the graphical representation 1000 depicts a scene 1002 including a LIDAR image rendered by the renderer using a third BRDF model, such as ABC model. The ABC model may refer to a reflectance model with three tunable parameters (A, B, C) used to accurately describe the reflectance properties of glossy and optically smooth surfaces. The parameter A may be related to the overall reflectance or amplitude. The parameter B may be related to the width of the specular peak. The parameter C may be related to the falloff rate of the specular lobe. As similarly described with reference to FIGS. 8A-8B, the renderer uses a different neural network trained for computing the specular compensation to apply to the third BRDF model for rendering the scene 1002. For example, the scene 1002 shows a LIDAR image rendered with the ABC model and an increasing ‘B’ parameter at a sampling rate of 16 samples per pixel (SPP). In FIG. 10A, the close-up 1004 in the scene 1002 is highlighted for another performance comparison in FIG. 10B.

In FIG. 10B, the graphical representation 1050 depicts a performance comparison of the renderer integrating the neural network for specular compensation against baseline implementation using the close-up 1004 of the rendered scene 1002 as an example. As similarly described with reference to FIG. 8B, the graphical representation 1050 in FIG. 10B depicts a first close-up 1004a of a scene rendered with no specular compensation applied to the third BRDF model and the corresponding hot spot analysis 1006a of the error in the first close-up 1004a. The graphical representation 1050 further depicts a second close-up 1004b of a scene rendered using a pre-computed data structure associated with the baseline implementation for applying specular compensation to the third BRDF model and the corresponding hot spot analysis 1006b of the error in the second close-up 1004b. The graphical representation 1050 further depicts a third close-up 1004c of a scene rendered using the non-linear neural network enhancement implementation for applying specular compensation to the third BRDF model and the corresponding hot spot analysis 1006c of the error in the third close-up 1004c. The graphical representation 1050 further depicts a fourth close-up 1004d of a reference scene against which the previous close-ups 1004a, 1004b, and 1004c are compared.

As similarly described with reference to FIGS. 8A-8B, the render times of the renderer for rendering each scene depicted in the first close-up 1004a, the second close-up 1004b, and the third close-up 1004c may be similar. However, the comparison of the corresponding hot spot analyses 1006a, 1006b, and 1006c shows that the output of the renderer integrating the neural network enhancement implementation for applying specular compensation to the third BRDF model provides the highest quality along with compact storage of neural network weights over the pre-computed data structure associated with the baseline implementation, with little to no change in render times. For example, the MrSE corresponding to each of the hot spot analyses 1006a, 1006b, and 1006c is 0.0019444, 0.0000089, and 0.0000014 respectively, which indicates that the output of the neural network enhancement implementation (e.g., third close-up 1004c) can be closer to the true values of the reference scene in the fourth close-up 1004d, reflecting better overall performance due to its lowest MrSE value. The visualization of the hot spot analysis 1006c for the third close-up 1004c shows that the neural network enhancement implementation provides at least a technical improvement to minimize or eliminate errors with respect to the reference scene. For example, the visualization of the hot spot analysis 1006c, when compared to the visualization of the hot spot analyses 1006a in red, is blue indicating low error. In another example, the visualization of the hot spot analysis 1006b is also blue but the MrSE corresponding to it is higher than that of the neural network-based approach.

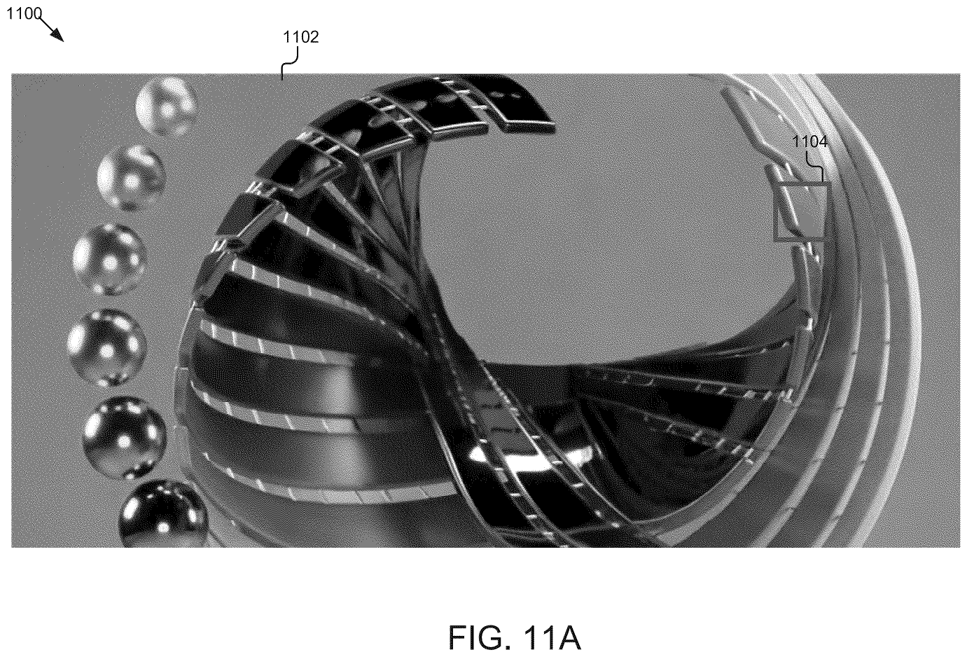

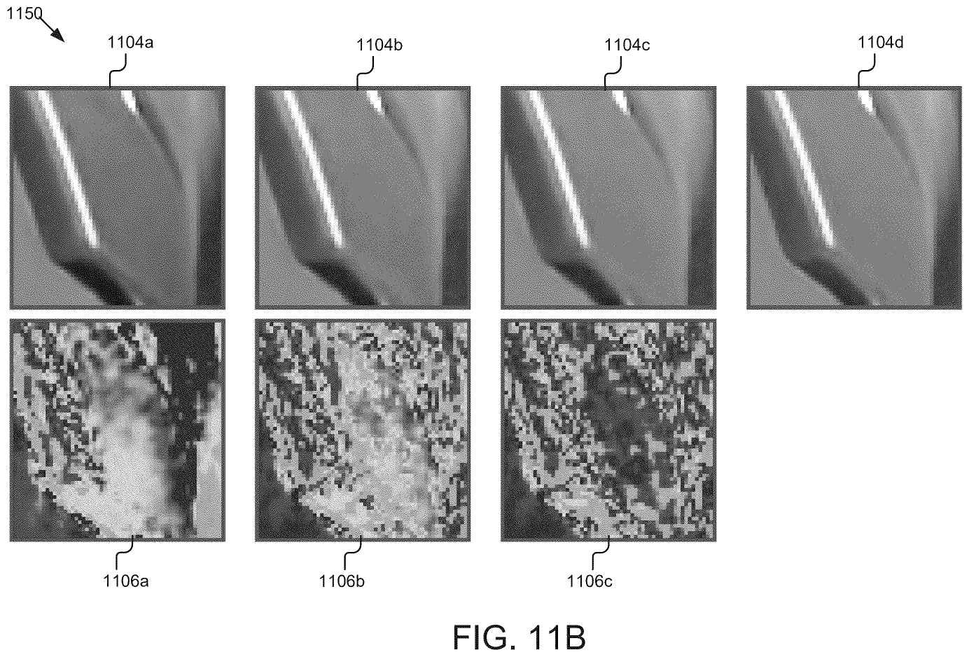

FIGS. 11A-11B illustrate graphical representations 1100-1150 depicting another example of a scene rendering and a performance comparison of a renderer in accordance with some implementations. In FIG. 11A, for example, the graphical representation 1100 depicts a complex scene 1102 that includes specular objects with both GGX and clearcoat layers and sharp, high-energy reflections rendered by the renderer using a neural network trained for computing the specular compensation to apply to the one or more BRDF models for rendering the scene 1102. It should be understood that to get noise-free results and properly preserve the scene detail, the scene 1102 was rendered with a large number of samples (e.g., 1024 samples per pixel). At such a high sampling rate, the render time of the neural network enhancement implementation may be longer (e.g., 50 seconds longer). The scenes at runtime may be typically rendered between 16 samples per pixel (SPP) to 256 samples per pixel (SPP) where differences in runtimes between the pre-computed data structure associated with the baseline implementation and the neural network enhancement implementation can be negligible (as in the rendering of the previous three scenes 802 in FIG. 8A, 902 in FIG. 9A, and 1002 in FIG. 10A). In FIG. 11A, the close-up 1104 in the scene 1102 is highlighted for another performance comparison in FIG. 11B.

In FIG. 11B, the graphical representation 1150 depicts a performance comparison of the renderer integrating the neural network for specular compensation against baseline implementation using the close-up 1104 of the rendered scene 1102 as an example. As similarly described with reference to FIG. 8B, the graphical representation 1150 in FIG. 11B depicts a first close-up 1104a of a scene rendered with no specular compensation applied to the BRDF model and the corresponding hot spot analysis 1106a of the error in the first close-up 1104a. The graphical representation 1150 further depicts a second close-up 1104b of a scene rendered using a pre-computed data structure associated with the baseline implementation for applying specular compensation to the BRDF model and the corresponding hot spot analysis 1106b of the error in the second close-up 1104b. The graphical representation 1150 further depicts a third close-up 1104c of a scene rendered using the non-linear neural network enhancement implementation for applying specular compensation to the BRDF model and the corresponding hot spot analysis 1106c of the error in the third close-up 1104c. The graphical representation 1150 further depicts a fourth close-up 1104d of a reference scene against which the previous close-ups 1104a, 1104b, and 1104c are compared.

The comparison of the corresponding hot spot analyses 1106a, 1106b, and 1106c shows that the output of the renderer integrating the neural network enhancement implementation for applying specular compensation to the BRDF model provides the highest quality along with compact storage of neural network weights over the pre-computed data structure associated with the baseline implementation. For example, the MrSE corresponding to each of the hot spot analyses 1106a, 1106b, and 1106c is 0.0232, 0.0021, and 0.0019 respectively, which indicates that the output of the neural network enhancement implementation (e.g., third close-up 1104c) can be closer to the true values of the reference scene in the fourth close-up 1104d, reflecting better overall performance due to its lowest MrSE value. The visualization of the hot spot analysis 1106c for the third close-up 1104c shows that the neural network enhancement implementation provides at least a technical improvement to minimize or eliminate errors with respect to the reference scene. For example, the hot spot analysis 1106c, when compared to each of the hot spot analyses 1106a and 1106b, predominantly shows cold spots of low errors.

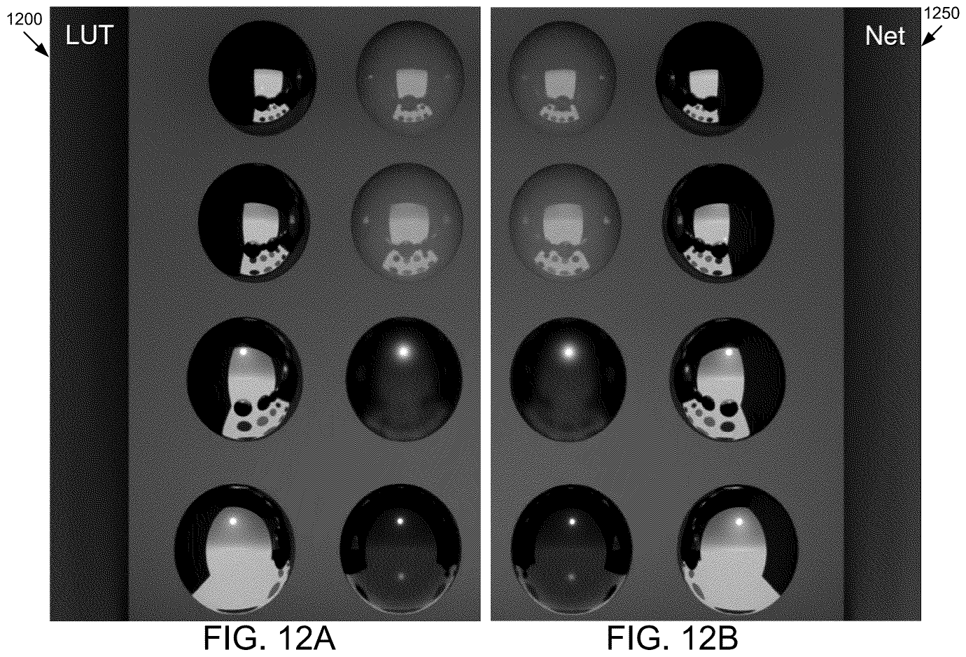

FIGS. 12A-12B illustrates graphical representations 1200 and 1250 depicting a performance of a renderer in accordance with some implementations. In FIG. 12A, the graphical representation 1200 depicts a first test render scene rendered using the pre-computed data structure associated with the baseline implementation. In FIG. 12B, the graphical representation 1250 depicts a second test render scene rendered using the neural network-based approach. For example, the test render scenes in FIGS. 12A-12B include spheres of varying materials with a wide range of glossiness and illuminated with an afternoon skydome (e.g., solar elevation at 50 degrees). The neural network enhancement implementation produces results with comparable quality relative to the pre-computed data structure associated with the baseline implementation. The quality across the two approaches is consistent. However, the neural network enhancement implementation avoids the memory and runtime overhead of the pre-computed data structure associated with the baseline implementation. The renderer implementing the neural network enhancement implementation may reduce the render times by 25-40% (depending on the scene's utilization of the skydome) while the saving the memory space (approximately the size of the pre-computed data structure) for additional runtime processing tasks. For example, for rendering the test render scene shown in the graphical representation 1250 of FIG. 12B, the neural network for skydome radiance estimation reduced the render times on average from 24 to 18 seconds and saved approximately 600 megabytes of memory space. In another example, the neural network for transmittance estimation also took 14 seconds (compared to the 24 seconds of the pre-computed data structure associated with the baseline implementation) in the renderer for rendering the test render scene shown in the graphical representation 1250.

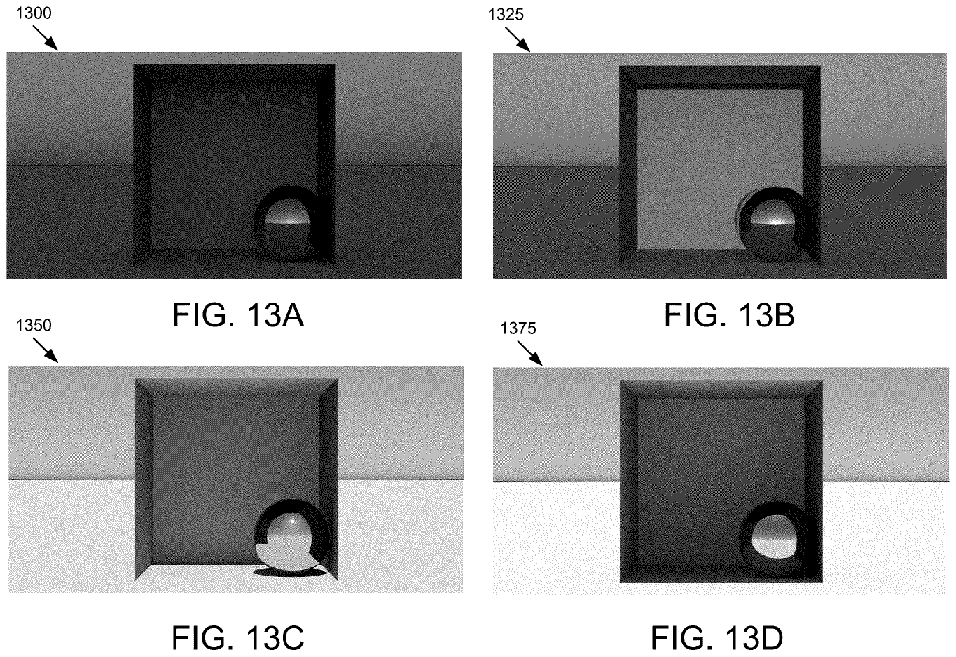

FIGS. 13A-13D illustrates graphical representation 1300-1375 depicting scenes rendered by a renderer in accordance with some implementations. The scenes include a metallic sphere inside a box having a glossiness and illuminated under a skydome. The scenes can be rendered based on inferring a skydome neural network (e.g., for sky radiance and solar radiance values) in the rendering pipeline. The solar radiance values may contribute to the amount of energy emitted by the sun for simulating sharp shadows, highlights, and overall brightness in the rendered scene. The sky radiance values may contribute to the amount of light emitted or scattered by the sky in a given direction for simulating realistic ambient outdoor lighting in the rendered scene. For example, the scenes may depict a location of the sun in the skydome at different times of the day and its corresponding influence on the atmospheric lighting conditions.

In FIG. 13A, the graphical representation 1300 depicts a scene rendered at sunset. The scene can be rendered using corresponding values of solar radiance and sky radiance inferred from a skydome neural network simulating a skydome where a location of the sun is near the horizon at sunset.

In FIG. 13B, the graphical representation 1325 depicts a scene rendered at sunrise. The scene can be rendered using corresponding values of solar radiance and sky radiance inferred from a skydome neural network simulating a skydome where a location of the sun is near the horizon at sunrise.

In FIG. 13C, the graphical representation 1350 depicts a scene rendered at mid-morning. The scene can be rendered using corresponding values of solar radiance and sky radiance inferred from a skydome neural network simulating a skydome where a location of the sun is roughly halfway up from the horizon.

In FIG. 13D, the graphical representation 1375 depicts a scene rendered at high noon. The scene can be rendered using corresponding values of solar radiance and sky radiance inferred from a skydome neural network simulating a skydome where a location of the sun is at its highest position above the horizon and casting a short shadow.

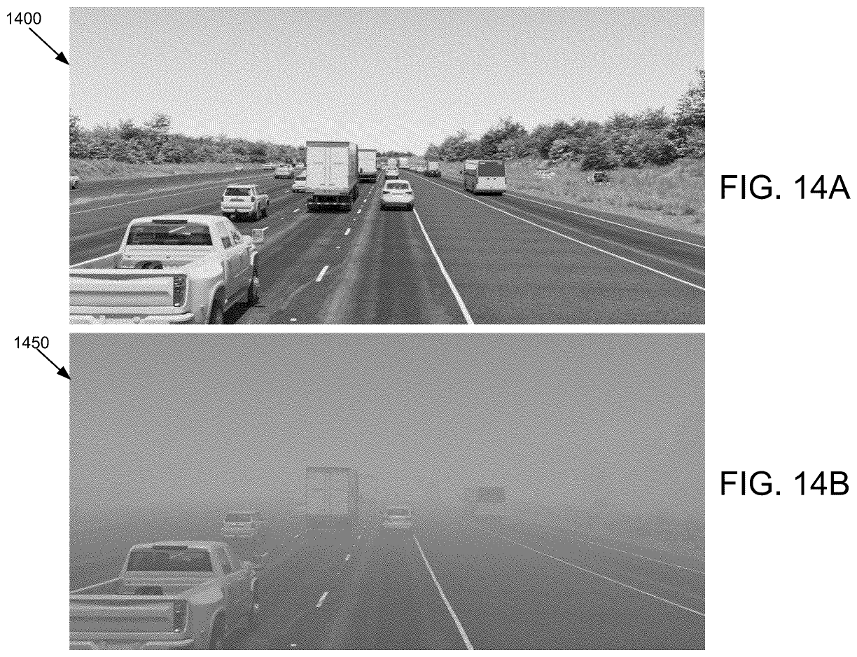

FIG. 14A-14B illustrate graphical representations 1400-1450 depicting example rendered frames from a renderer in accordance with some implementations. The rendered frames include a depiction of a highway with multiple lanes of traffic. The frames can be rendered based on inferring the transmittance neural network (e.g., for transmittance values) in the rendering pipeline. For example, the transmittance values may contribute to the fraction of light that passes through the atmosphere after accounting for absorption and scattering for simulating atmospheric attenuation of the sky radiance and the solar radiance in the rendered frame.

In FIG. 14A, the graphical representation 1400 depicts an example frame rendered with haziness set to zero. The frame can be rendered using corresponding values of transmittance inferred from the transmittance neural network to simulate a haze-free atmosphere with clear visibility.

In FIG. 14B, the graphical representation 1450 depicts an example frame rendered with haziness set to one. The frame can be rendered using corresponding values of transmittance inferred from the transmittance neural network to simulate a hazy or foggy atmosphere with low visibility.

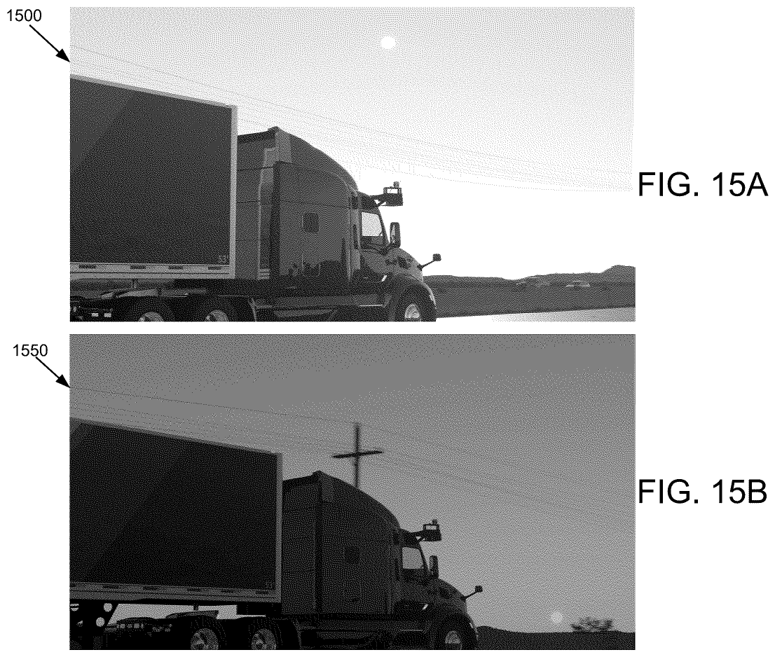

FIGS. 15A-15B illustrate graphical representations 1500-1550 depicting example rendered frames from a renderer in accordance with some implementations. The renderer may infer a combination of one or more neural networks for rendering the frames in the rendering pipeline. For example, the renderer may infer a combination of the one or more specular compensation networks (e.g., for specular compensation values), the skydome network (e.g., for sky radiance and solar radiance values), and the transmittance network (e.g., for transmittance values).

The graphical representations 1500-1550 in FIGS. 15A-15B highlight the changing settings of the skydome in the rendered frames. The rendered frames include a depiction of a moving truck with a dark and glossy paint surface.

In FIG. 15A, the graphical representation 1500 depicts a scene rendered using a first setting of the sun in the skydome. The scene can be rendered using (a) the values of solar radiance and sky radiance inferred from the skydome network simulating a skydome where a location of the sun is roughly halfway between the high noon position and the horizon, (b) the values of transmittance inferred from the transmittance network simulating the atmospheric attenuation of the sky radiance and the solar radiance, and (c) the specular compensation values inferred from the one or more specular compensation networks for offsetting the energy loss in the rendering pipeline.

In FIG. 15B, the graphical representation 1550 depicts a scene rendered using a second setting of the sun in the skydome. The scene can be rendered using (a) the values of solar radiance and sky radiance inferred from the skydome neural network simulating a skydome where a location of the sun is near the horizon at sunset, (b) the values of transmittance inferred from the transmittance neural network simulating the atmospheric attenuation of the sky radiance and the solar radiance, and (c) the specular compensation values inferred from the specular compensation neural network for offsetting the energy loss in the rendering pipeline.

The previous description is provided to enable practice of the various aspects described herein. Various modifications to these aspects will be understood, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order, and are not meant to be limited to the specific order or hierarchy presented.

The previous description of the disclosed implementations is provided to enable others to make or use the disclosed subject matter. Various modifications to these implementations will be readily apparent, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated, the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be implemented in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable others to make or use the present disclosure. Various modifications to these examples will be readily apparent, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A method, comprising:
identifying a trained neural network including one or more parameters based on a specification of a pipeline element within a pipeline, the pipeline element corresponding to one or more operations executable by a central processing unit (CPU), the pipeline corresponding to a runtime environment having a low latency, the trained neural network generating a predicted output corresponding to a baseline output of the pipeline element in the runtime environment;
sending an input associated with the pipeline to the trained neural network in the runtime environment; and
generating the predicted output associated with the pipeline in the runtime environment based on the trained neural network, the trained neural network corresponding to one or more operations executable by the CPU.

2. The method of claim 1, further comprising:
determining a plurality of threads asynchronously invoking the trained neural network in the runtime environment;
for a respective one of the plurality of threads asynchronously invoking the trained neural network in the runtime environment, normalizing an input of the respective one of the plurality of threads before sending the input to the trained neural network in the runtime environment; and
independently inferring the trained neural network based on the input of the respective one of the plurality of threads to generate a predicted output, a batch size of the input of the respective one of the plurality of threads including one or more elements of data.

3. The method of claim 1, further comprising:
sending the predicted output of the trained neural network to an input of another pipeline element within the pipeline in the runtime environment.

4. The method of claim 1, further comprising:
converting one or more weights of the trained neural network into one or more static matrices; and
at least partially replacing the pipeline element in the runtime environment with the trained neural network by importing the one or more static matrices into the runtime environment.

5. The method of claim 4, further comprising:
inferring, using the one or more static matrices and one or more CPU-based libraries, the trained neural network as a series of matrix multiplication operations and parallelized activation function evaluations executable by the CPU.

6. The method of claim 5, wherein the one or more CPU-based libraries enable vectorization of the series of matrix multiplication operations and the parallelized activation function evaluations executable by the CPU.

7. The method of claim 1, wherein the trained neural network is previously trained outside of the runtime environment using ground truth data associated with the pipeline element.

8. The method of claim 7, wherein the ground truth data associated with the pipeline element is dynamically generated based on querying a pre-computed data structure associated with the pipeline element using a plurality of samples of input data.

9. The method of claim 7, wherein the ground truth associated with the pipeline element is dynamically generated based on evaluating a quantitative model associated with the pipeline element using a plurality of samples of input data.

10. The method of claim 1, wherein:
the specification of the pipeline element includes one or more inputs, one or more outputs, a memory size, and a measure of computational performance, and
the trained neural network is configured to include the one or more parameters subject to a constraint that a memory size of the neural network is lower and a measure of computational performance of the neural network is greater than that of the pipeline element for the one or more inputs and the one or more outputs.

11. The method of claim 7, wherein the ground truth data associated with the pipeline element is fully regenerated every predetermined number of iterations.

12. The method of claim 7, wherein:
a cache of the ground truth data associated with the pipeline element is supplemented with new ground truth data every predetermined number of iterations, and
the trained neural network is previously trained outside of the runtime environment based on sampling the cache of the ground truth data.

13. The method of claim 1, wherein the pipeline includes a high-performance rendering application.

14. The method of claim 1, wherein the trained neural network in the runtime environment includes at least one from a group of a specular bidirectional reflectance distribution function compensation model and an atmospheric radiance evaluation model.

15. The method of claim 1, wherein the trained neural network includes a multilayer perceptron.

16. A system comprising one or more processors and memory operably coupled with the one or more processors, wherein the memory stores instructions that, in response to the execution of the instructions by one or more processors, cause the one or more processors to perform operations including:
identifying a trained neural network including one or more parameters based on a specification of a pipeline element within a pipeline, the pipeline element corresponding to one or more operations executable by a central processing unit (CPU), the pipeline corresponding to a runtime environment having a low latency, the trained neural network generating a predicted output corresponding to a baseline output of the pipeline element in the runtime environment;
sending an input associated with the pipeline to the trained neural network in the runtime environment; and
generating the predicted output associated with the pipeline in the runtime environment based on the trained neural network, the trained neural network corresponding to one or more operations executable by the CPU.

17. The system of claim 16, wherein the operations further comprise:
determining a plurality of threads asynchronously invoking the trained neural network in the runtime environment;
for a respective one of the plurality of threads asynchronously invoking the trained neural network in the runtime environment, normalizing an input of the respective one of the plurality of threads before sending the input to the trained neural network in the runtime environment; and
independently inferring the trained neural network based on the input of the respective one of the plurality of threads to generate a predicted output, a batch size of the input of the respective one of the plurality of threads including one or more elements of data.

18. The system of claim 16, wherein the operations further comprise:
converting one or more weights of the trained neural network into one or more static matrices; and
at least partially replacing the pipeline element in the runtime environment with the trained neural network by importing the one or more static matrices into the runtime environment.

19. The system of claim 18, wherein the operations further comprise:
inferring, using the one or more static matrices and one or more CPU-based libraries, the trained neural network as a series of matrix multiplication operations and parallelized activation evaluations executable by the CPU.

20. The system of claim 19, wherein the one or more CPU-based libraries enable vectorization of the series of matrix multiplication operations and the parallelized activation function evaluations executable by the CPU.
